(19) United States
(12) Patent Application Publication
(10) Pub. No.: US 2024/0251258 A1
(43) Pub. Date: Jul. 25, 2024

(54) Method, UE and Network Node for Handling MPM Re-Configuration in a Communications Network

(71) Applicant: Telefonaktiebolaget LM Ericsson (publ), Stockholm (SE)

(72) Inventors: Victor Farias Monteiro, Fortaleza (BR); Mehdi Abad, Aachen (DE); Icaro Leonardo Da Silva, Solna (SE)

(21) Appl. No.: 18/562,388

(22) PCT Filed: May 17, 2022
(86) PCT No.: PCT/SE2022/050477

§ 371 Date: Nov. 20, 2023

Related U.S. Application Data
(60) Provisional application No. 63/195,726, filed on Jun. 2, 2021.

(51) Int. Cl. H04W 24/02; H04W 36/00; H04W 36/32

(52) U.S. Cl. CPC H04W 24/02; H04W 36/0058; H04W 36/32

(57) ABSTRACT

The present disclosure relates to a method performed by a UE (105) for handling MPM re-configuration in a communications system (100). The UE (105) is configured with a first MPM. The UE (105) performs mobility predictions using the first MPM. The CE (105) provides a report from the mobility predictions to a network node (101). The UE (105) obtains MPM re-configuration information from the network node (101). The UE (105) preforms MPM re-configuration according to the obtained MPM-re-configuration information.

### TECHNICAL FIELD

The present disclosure relates generally to a User Equipment (UE), a method performed by the UE, a network node and a method performed by the network node.

More particularly, the present disclosure relates to handling Mobility Prediction Model (MPM) re-configuration in a communications system. The re-configuration of MPM may be assisted by UE reporting.

### BACKGROUND

Mobility prediction and artificial intelligence (AI)/machine learning (ML) applied to radio access networks

Recently, many works have been dedicated to study mobility prediction. By mobility prediction it is often referred to the technique to predict that a given UE is going to leave the coverage of a source cell and is going to enter the coverage of a neighbour cell before it does, i.e., even before the UE reports a measurement report to the network associated to an A3 like event, e.g., that the neighbour offset better than source, the network figures out that the event is going to happen before it happens, with a certain likelihood, of course. Some of the applications and scenarios addressed by these works are:
Handover anticipation: In small and densified mmWave cellular networks, frequent Handovers (HO) and the resultant high switching latency degrade the system performance, which is further exacerbated by the fact that a mmWave channel is vulnerable to the line-of-sight (LOS) blockage, leading to sudden drops or outage of the signal. In this type of scenario, mobility prediction may be used to alleviate the mentioned problems by starting the handover process ahead of time. In the baseline process without predictions, the UE sends a measurement report, the source node prepares the target cell possibly in a target node, target node gives the source node the reconfiguration, e.g., in a container, the source node gives the reconfiguration to the UE, e.g., an RRCReconfiguration with a reconfiguration with sync, the UE receives the RRCReconfiguration properly and the UE accesses the target cell in the target node. RRC is short for Radio Resource Control. Note that the inter-node messages exchange and the processing time in both the source node and the target node may take some time, so that it may be a significant delay from the time the UE sends the measurement report, i.e., from the time the A3 condition for HO is fulfilled, to the time the UE gets the RRCReconfiguration with target configuration. The target node may be a target base station or a target network node and the source node may be a source base station or a source network node.
Keeping UE's continuous connection: This type of application is usually addressed by works considering delay sensitive services, where, based on the prediction of a moving UE's next position, the network proactively prefetch the user content to edge catching base stations, guaranteeing data delivery performance with near-zero delay, e.g., seamless handover. Compared to the previous discussion, this benefit is more related to the user plane data delivery.
Load balancing: Works considering mobility prediction and the expected growth of mobile traffic in Fifth Generation (5G) networks have used the prior knowledge of UE mobility to predict time-varying traffic load and offload part of the traffic to small cells, e.g., turn on/off, for preventing the network from congesting.
Location Based Services (LBSs): LBSs aims to enhance users' experience through services related to the users' specific location, e.g., sending target advertisements, local traffic information, instant communication with UE's nearby and merchant recommendation. However, real time geographical location is a critical issue, e.g., Global Positioning System (GPS) is unsuitable for indoor location estimation. In this context, works related to LBSs and mobility prediction usually benefit of foreknowing where the UEs will be in the future.

Despite considering different approaches, the frameworks for mobility prediction are usually network based and structured as illustrated in FIG. 1. In summary, a central node, e.g., the serving base station, aggregates UE periodically reported data, such as location history and received signal strength, and use this data as input for prediction algorithms. The prediction outputs represent what the central node desires to acquire through prediction, e.g., transition probability or future location.

In more detail, FIG. 1 shows three categories of applications: handover management 301, resource management 302 and location-based services 303. FIG. 1 shows the following performance matrices: prediction accuracy 304, deviation error 305, handover dropping probability 306 and new call blocking probability 307. Procedures of mobility prediction are input from the applications to the performance matrices. Evaluating results from prediction outputs such as moving direction 308, transition probability 309, future location 310, user trajectory 311 and the next cell ID 312 are provided to the performance matrices. FIG. 1 shows prediction algorithms such as Markov chain 313, Hidden Markov model 314, artificial neural network 315, Bayesian network 316 and data mining 317, which provides prediction outputs. FIG. 1 shows the following required information: location information 318, cell transition history 319, road topology information 320, user behavior 321 and received signal strength 322, which provides extracted knowledge to the prediction algorithms. Data is collected from the UE, the base station, data server 350, the satellite 360 and the sensor 370.

Regarding specifically the prediction algorithms, the recent ones are mostly based on ML. Although the terms Al and ML are sometimes interchangeably used, this may be seen as a misconception. ML is a sub-field of Al, as well as game theory and control theory. In general, ML encompasses methods that learn from data.

Al/ML in 3GPP: network-centric (Rel-17) vs. UE-centric (Rel-18 and 6G) Network-centric AI/ML

One known approach and assumptions in the latest Third Generation Partnership Project (3GPP) study item on Al/ML, i.e. Rel-16, are based on prediction models at the network side, and these models are trained based on information reported from the UEs. These assumptions rely on the network predicting quantities of interest, such as mobility patterns, received signal strength/quality, e.g., Reference Signal Received Power (RSRP), Reference Signal Received Quality (RSRQ), to make timely and intelligent decisions. It is a focus on application of Al/ML on the network side. Predictions of parameters such as RSRP, RSRQ, call drop, mobility patterns of the UEs, target cell in a handover are examples of use cases where Al/ML has been utilized in the network side for further optimization.

3GPP has started to discuss Al/ML use cases in Rel-17. Operators see traditional human-machine interaction as slow, error-prone, expensive, and it is cumbersome to handle these challenges. Al comprising ML algorithms provide a powerful tool to help operators to improve the network management and the user experience by analyzing the data collected and autonomously processed that may yield further insights. Application of Al in 5G networks has gained tremendous attention in both academia and industry.

Therein, it is assumed that most of the Al algorithms may be up to the network implementation. The focus will be on signaling support for training and the execution involved in Al schemes, the data required by the Al algorithms, e.g., potentially reported by the UE or collected from different parts of the network, and outputs generated by the algorithms to be delivered to other network nodes or Network Functions (NFs) in Radio Access Network (RAN), Core Network (CN), or Operation and Maintenance (OAM)/CHM. Potential use cases and examples that are mentioned comprise energy saving, traffic steering, mobility optimization, load balancing, physical layer configuration optimization, etc.

Hence, up to 3GPP Release 17 (Rel-17), the focus of AI/ML has been on data collection to support NFs to generate their Al/ML models. However, in initial discussions for Release 18 (Rel-18), a new paradigm started to emerge and concepts where the UE had its own Al/ML models started to be discussed. Although there is no clear scope of Rel-18 defined yet, such a trend of UE-centric Al/ML tends to increase and, the initial publications on the Sixth Generation (6G) considers Al/ML as one of the main technical components, i.e., it is very likely that at least some applications may rely on prediction functions at the UE, and not just at the network side.

In a typical communications system, a UE communicates via a RAN to one or more CNs. The communications system may be referred to as e.g., a wireless communications network, a wireless communications system, a communications network, a communications network, a network or a system.

### UE-centric AI/ML

A UE-centric Al/ML approach to integrate the Al/ML models on the UE side, e.g., as part of the air interface protocols such as part of RRC functions like measurement configuration/reporting has previously been proposed. In certain scenarios, this approach may provide advantages over the network centric approach. This is because there is internal information at the UE side that are not exposed to the network such as out-of-sync events, sensors whose info is not standardized, information from the application layer, e.g., app traffic demands, not easily available at some network functions, like the RAN, gNodeBs, etc. Another reason may be that the UE has access to the fresh values with more granularity while the network is limited by the communication latency and the amount of data sent by the UE to the network, although the UE may have some measurements it may not report it to the network because of communication and energy efficiency.

For the UE-centric Al/ML scenario, the UE may have an Al/ML prediction model to predict mobility related information, such as future values of RSRP, Reference Signal Received Quality (RSRQ) or Signal to Interference plus Noise Ratio (SINR), or the next cell the UE may move to. And these predictions may be comprised in measurement reports, e.g., triggered by an A3 event, e.g., based on RSRP, RSRQ, SINR measurements, and these reports are transmitted to the network.

The UE may have an Al/ML prediction model to predict mobility related information, such as future values of RSRP, RSRQ or SINR, or the next cell the UE may move to, and, these predictions are used as input to the triggering condition that triggers the transmission of a prediction report, e.g. predictions may trigger a special type of A3 event based on RSRP, RSRQ, SINR predictions, and these prediction reports are transmitted to the network.

The known mobility prediction procedures at the UE side assume that the UE has a prediction model for measurements/mobility, e.g. model predicting RSRP, RSRQ, SINR, and comprises the possibility of providing a prediction model to the UE in different manners, such as i) the UE downloads a Software (SW) that the UE runs upon reception and that enables the UE to use the prediction model, wherein the model may have been trained by the network; ii) the UE is configured with a prediction model, e.g. upon connection setup, via RRC signaling or Non-Access Stratum signaling, or any other control plane signaling, like using an Over the Top (OTT) protocol.

However, the radio environment may differ quite a lot within the whole network, e.g., some areas with LOS, some areas with No LOS (NLOS), some areas with more reflectors than others, e.g., relevant for higher frequencies, like mmWave, some areas with buildings and without buildings, etc. Hence, using the same AI/ML prediction model for mobility predictions, e.g. RSRP, RSRQ, SINR predictions, may not be ideal and may lead to low accuracy overall i.e. it may lead to wrong predictions, hence sub-optimal UE and/or network actions in response. Even within the same cell, these different conditions may occur, depending on how large is the coverage area defined by the cell, which depends on network planning and carrier frequency defined for that cell, e.g., New Radio

Synchronization Signal Block (NR SSB) frequency, and how diverse is the radio environment. Besides, even at the same position, the environment conditions may change along the time. For example, new objects may enter the environment attenuating or even blocking the signal, which demands a new prediction model for that environment considering the existence of the new objects.

Therefore, there is a need to at least mitigate or solve this issue.

### SUMMARY

An object of the present disclosure is to obviate at least one of the above disadvantages and to provide improved handling of MPM in the communication system.

According to a first aspect, the object is achieved by a method performed by a UE for handling MPM re-configuration in a communications system. The UE is configured with an MPM. The UE performs mobility predictions using the MPM. The UE provides a report from the mobility predictions to the network node. The UE obtains MPM re-configuration information from the network node. The UE performs MPM re-configuration according to the obtained MPM re-configuration information.

According to a second aspect, the object is achieved by a method performed by a network node for handling MPM re-configuration in a communications system. The network node obtains a report from the mobility predictions from a UE. The network node determines that MPM re-configuration should be performed. The network node provides MPM re-configuration information to the UE.

According to a third aspect, the object is achieved by a UE for handling MPM re-configuration in a communications system. The UE is configured with a first MPM. The UE is adapted to perform the method according to the first aspect.

According to a fourth aspect, the object is achieved by a network node for handling MPM re-configuration in a communications system. The network node is adapted to perform the method according to the second aspect.

Thanks to the report from the mobility predictions, the network node is able to determine that MPM re-configuration should be performed, and consequently the UE performs the MPM re-configuration. Thus, the handling of MPM in the communication system is improved.

The present disclosure herein affords many advantages, of which a non-exhaustive list of examples follows:

An advantage of the present disclosure is that it is possible that the UE has the MPM re-configured, so that accuracy of the reported information based on MPM is improved and the error is reduced.

Another advantage of the present disclosure is that it allows a dynamic update of prediction models used by the UE based on current prediction error.

A further advantage of the present disclosure is that it reduces the error of predictions performed by a UE.

Another advantage of the present disclosure is that it allows preventive actions when a high prediction error is detected.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more details by way of example only in the following detailed description by reference to the appended drawings in which:

FIG. 1 is a schematic block diagram illustrating mobility prediction.

FIG. 2 is a schematic drawing illustrating a communications system.

FIG. 3 is a signaling diagram illustrating a method.

FIG. 4 is a signaling diagram illustrating a method.

FIG. 5 is a graph illustrating RSRP vs. time.

FIG. 6 is a graph illustrating RSRP vs. time.

FIG. 7 is a table illustrating root means square error and action.

FIG. 8 is a signaling diagram illustrating a method.

FIG. 9 is a signaling diagram illustrating a method.

FIG. 10 is a signaling diagram illustrating a method.

FIG. 11 is a signaling diagram illustrating a method.

FIG. 12 is a flow chart illustrating a method performed by a UE.

FIG. 13 is a flow chart illustrating a method performed by a network node.

FIG. 14a is a schematic drawing illustrating a UE.

FIG. 14b is a schematic drawing illustrating a UE.

FIG. 15a is a schematic drawing illustrating a network node.

FIG. 15b is a schematic drawing illustrating a network node.

FIG. 16 is a schematic block diagram illustrating a telecommunication network connected via an intermediate network to a host computer.

FIG. 17 is a schematic block diagram of a host computer communicating via a base station with a UE over a partially wireless connection.

FIG. 18 is a flowchart depicting a method in a communications system comprising a host computer, a base station and a UE.

FIG. 19 is a flowchart depicting a method in a communications system comprising a host computer, a base station and a UE.

FIG. 20 is a flowchart depicting a method in a communications system comprising a host computer, a base station and a UE.

FIG. 21 is a flowchart depicting a method in a communications system comprising a host computer, a base station and a UE.

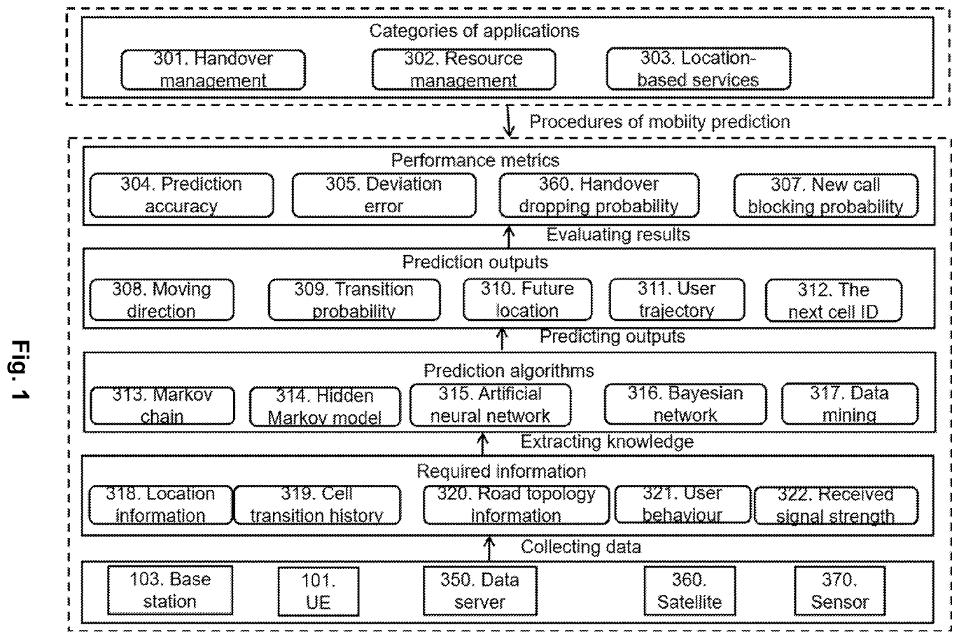

The drawings are not necessarily to scale, and the dimensions of certain features may have been exaggerated for the sake of clarity. Emphasis is instead placed upon illustrating the principle.

### DETAILED DESCRIPTION

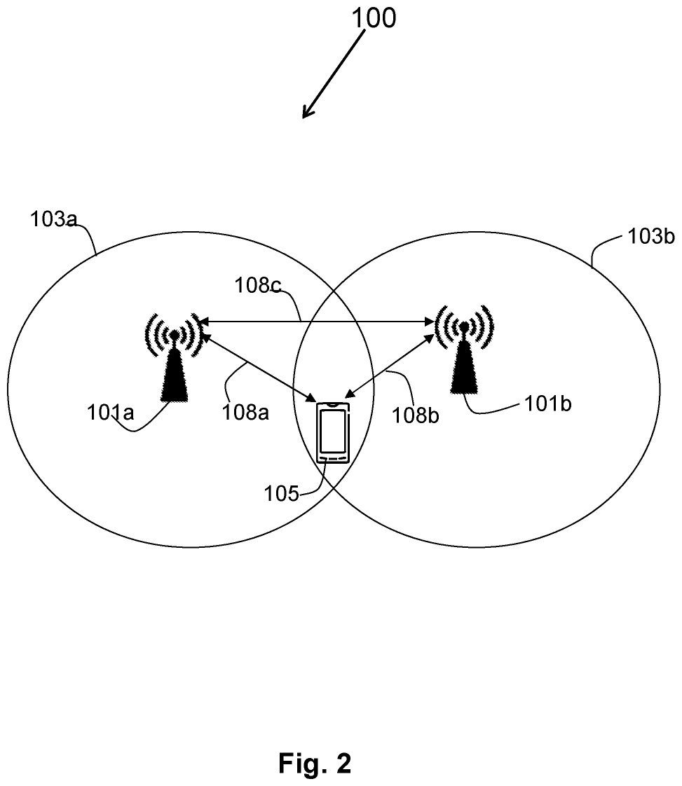

FIG. 2 depicts a non-limiting example of a communications system 100, which may be a wireless communications system, sometimes referred to as a wireless communications network, cellular radio system, or cellular network, in which the present disclosure may be implemented. The communications system 100 may be a 5G system, 5G network, NR-U or Next Gen system or network. The communications system 100 may alternatively be a younger system or older system than a 5G system, such as e.g. a 2G system, a 3G system, a 4G system, a 6G system, a 7G system etc. The communications system 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IOT. Thus, although terminology from 5G/NR and LTE may be used in this disclosure to exemplify, this should not be seen as limiting to only the aforementioned systems.

The communications system 100 comprises one or a plurality of network nodes, whereof a first network node 101a and a second network node 101b are depicted in the non-limiting example of FIG. 2. Any of the first network node 101a, and the second network node 101b may be a radio network node, such as a radio base station, or any other network node with similar features capable of serving a user equipment, such as a wireless device or a machine type communication device, in the communications system 100. The first network node 101a may be an eNB and the second network node 101b may be a gNB. The first network node 101a may be a first eNB, and the second network node 101b may be a second eNB. The first network node 101a may be a first gNB, and the second network node 101b may be a second gNB. The first network node 101a may be a MeNB and the second network node 101b may be a gNB. Any of the first network node 101a and the second network node 101b may be co-localized, or they may be part of the same network node. The first network node 101a may be referred to as a source node or source network node, whereas the second network node 101b may be referred to as a target node or target network node. When the reference number 101 is used herein without the letters a or b, it refers to a network node in general, i.e., it refers to any of the first network node 101a or second network node 101b.

The communications system 100 covers a geographical area which may be divided into cell areas, wherein each cell area may be served by a network node, although, one network node may serve one or several cells. In FIG. 2, the communications system 100 comprises a first cell 103a and a second cell 103b. Note that two cells are exemplified in FIG. 2 only as an example, and that any n number of cells may be comprised in the communication system 100, where n is any positive integer. A cell is a geographical area where radio coverage is provided by the network node at a network node site. Each cell is identified by an identity within the local network node area, which is broadcast in the cell. In FIG. 2, first network node 101a serves the first cell 103a, and the second network node 101b serves the second cell 103b. Any of the first network node 101a and the second network node 101b may be of different classes, such as, e.g., macro base station (BS), home BS or pico BS, based on transmission power and thereby cell size. Any of the first network node 101a and the second network node 101b may be directly connected to one or more core networks, which are not depicted in FIG. 2 for the sake of simplicity. Any of the first network node 101a and the second network node 101b may be a distributed node, such as a virtual node in the cloud, and it may perform its functions entirely on the cloud, or partially, in collaboration with another network node. The first cell 103a may be referred to as a source cell, whereas the second cell 103b may be referred to as a target cell. When the reference number 103 is used herein without the letters a or b, it refers to a cell in general, i.e., it refers to any of the first cell 103a or second cell 103b.

One or a plurality of UEs 105 is comprised in the communication system 100. Only one UE 105 is exemplified in FIG. 2 for the sake of simplicity. A UE 105 may be referred to simply as a device. The UE 105, e.g. a LTE UE or a 5G/NR UE, may be a wireless communication device which may be known as e.g., a wireless device, a mobile terminal, wireless terminal and/or mobile station, a mobile telephone, cellular telephone, or laptop with wireless capability, just to mention some examples. The UE 105 may be a device by which a subscriber may access services offered by an operator's network and services outside operator's network to which the operator's radio access network and core network provide access, e.g. access to the Internet. The UE 105 may be any device, mobile or stationary, enabled to communicate over a radio channel in the communications system 100, for instance but not limited to e.g. UE, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC). The UE 105 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the communications system 100.

The UE 105 is enabled to communicate wirelessly within the communications system 100. The communication may be performed e.g. between two UEs 105, between a UE 105 and a regular telephone, between the UE 105 and a network node 101, between network nodes, and/or between the UE 105 and a server via the radio access network and possibly one or more core networks and possibly the internet.

The first network node 101a may be configured to communicate in the communications system 100 with the UE 105 over a first communication link 108a, e.g., a radio link. The second network node 101b may be configured to communicate in the communications system 100 with the UE 105 over a second communication link 108b, e.g., a radio link. The first network node 101a may be configured to communicate in the communications system 100 with the second network node 101b over a third communication link 108c, e.g., a radio link or a wired link, although communication over more links may be possible. When the reference number 108 is used herein without the letters a, b or c, it refers to a communication link in general, i.e., it refers to any of the first communication link 108a, the second communication link 108b and the third communication link 108c.

It should be noted that the communication links 108 in the communications system 100 may be of any suitable kind comprising either a wired or wireless link. The link may use any suitable protocol depending on type and level of layer (e.g., as indicated by the Open Systems Interconnection (OSI) model) as understood by the person skilled in the art.

The present disclosure relates to re-configuring of a MPM used by a UE 105, possibly assisted by or based the report by the UE 105 of the MPM related information, such as the error and/or accuracy of the MPM. The MPM related information may indicate an MPM performance metric, indicating how good and/or how poor the MPM's performance is.

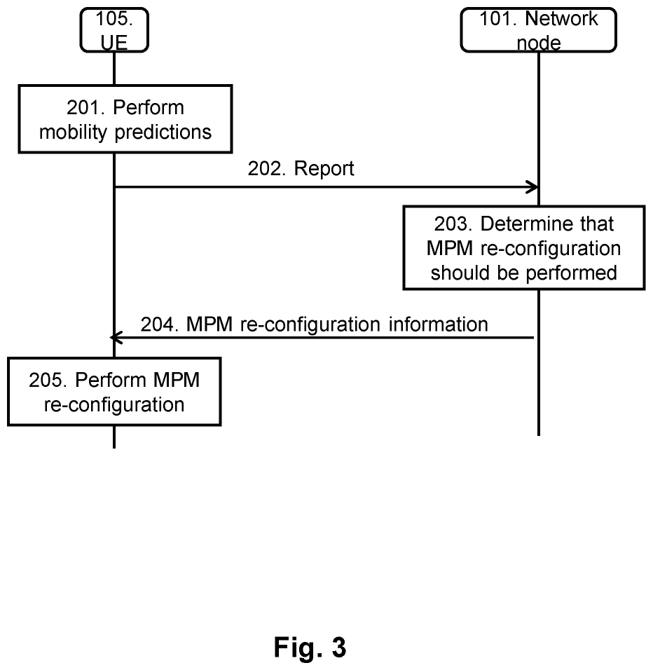

The method for handling MPM re-configuration in a communications system 100 will now be described with reference to the signalling diagram depicted in FIG. 3. The method comprises at least one of the following steps, which steps may as well be carried out in another suitable order than described below.

### Step 201

The UE 105 performs mobility predictions using an MPM. Before step 201 is performed, the UE 105 is configured with the MPM, e.g., a first MPM, a current MPM. The performance of the mobility predictions may be triggered by that the UE 105 is configured with the MPM by the network node 101, by receipt of instructions from the network node 101, by that an event takes place in or associated with the UE 105 or triggered by any other suitable means.

### Step 202

The UE 105 provides a report of the mobility predictions to the network node 101. The content of the report will be described in more detail below. The network node 101 obtains the report from the UE 105.

### Step 203

The network node 101 determines that MPM re-configuration should be performed. The decision may be taken based on the report from step 202. The network node 101 creates MPM re-configuration information as part of step 203, e.g., instructions that MPM re-configuration should be performed, information about the re-configuration etc.

### Step 204

The network node 101 provides MPM re-configuration information to the UE 105. The UE 105 obtains the MPM re-configuration information from the network node 101. This may be described as the UE 105 receives the MPM re-configuration from the network node 101.

### Step 205

The UE 105 performs the MPM re-configuration according to the obtained MPM-re-configuration information. How the MPM re-configuration will be performed will be described in more detail below.

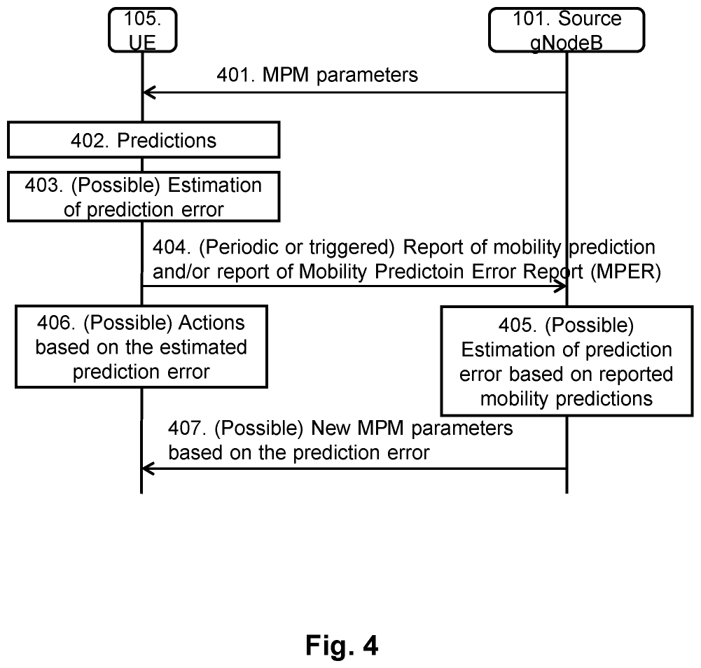

The method for handling MPM re-configuration in a communications system 100 will now be described with reference to the signalling diagram depicted in FIG. 4. Compared to FIG. 3, FIG. 4 comprises more details of the method steps. The network node 101 is exemplified with a source gNodeB in FIG. 4, but may equally be any other suitable network node. FIG. 4 describes a signalling exchange allowing the reconfiguration of a MPM used by a UE 105 based on prediction error estimation. The method comprises at least one of the following steps, which steps may as well be carried out in another suitable order than described below.

### Step 401

The source gNodeB 101 provides one or more MPM parameters to the UE 105. The MPM parameter(s) may be comprised in an MPM. This may be described as the source gNodeB 101 configures the UE 105 with the MPM. The MPM may be a first MPM, an initial MPM, a current MPM etc.

### Step 402

This step corresponds to step 201 in FIG. 3. The UE 105 performs mobility predictions. The mobility predictions may be triggered by receipt of the MPM parameters in step 401 or by any other triggering means. The mobility predictions may provide one or more mobility predictions parameters.

### Step 403

This may be an optional step. The UE 105 may perform an estimation of a prediction error, e.g. an error related to the mobility predictions that was performed in step 402. The error may be estimated by comparing a result of the predictions in step 402 with reference values or reference parameters.

### Step 404

This step corresponds to step 202 in FIG. 3. The UE 105 may provide a report of the mobility predictions to the source gNodeB 101. In addition to the report or instead of the report, the UE 105 may provide a mobility prediction error report (MPER) to the source gNodeB 105. The report(s) may be provided periodically or it may be triggered.

### Step 405

This may be an optional step. The source gNodeB 101 may estimate a prediction error based on the reported mobility predictions. When this step is performed, step 404 may not necessarily comprise the MPER.

### Step 406

This may be an optional step. The UE 105 may take an action based on the estimated prediction error. The action will be described in more detail later. The action may be referred to as an autonomous action.

### Step 407

This step may correspond at least partly to step 204 in FIG. 4. The source gNodeB 101 provides MPM re-configuration information to the UE 101. The source gNodeB 101 provides new MPM parameters to the UE 101. The new MPM parameters may be based on the prediction error from step 405 if step 405 was performed or from the MPER report if it was received in step 404. The new MPM parameters may be comprised in the MPM re-configuration information. The new MPM parameters may be updated parameters compared to the ones form step 401, it may be completely different parameters, it may be parameters that should replace the ones from step 401 etc.

FIG. 4 may be summarized as follows: The UE 105 receives a MPM configuration from the network node 101 and uses this model to perform mobility predictions e.g. predicted RSRP, prediction RSRQ, predicted SINR, next cell or beam, SSB, Channel State Information-Reference Signal (CSI-RS), predict whether the UE 105 is moving to or entering the coverage of, etc. The predictions may later be compared with the real values or reference values, e.g. RSRP measured at a given point in time, possibly filtered by the UE 105 and/or by the network node 101. If the prediction error, e.g. MPM output error, is estimated by the UE 105, it may report this information to the network node 101 either in a specific report, called MPER or comprised in another report, e.g., a measurement report. The report of prediction error may be sent by the UE 105 to the network node 101 either periodically or based on triggering events. Based on a received report of prediction error or on its own estimation of prediction error, the network node 101 may signal to the UE 105 either a new configuration for the MPM or a new MPM or even deactivate predictions. Besides, the network node 101 may configure the UE 105 with autonomous actions that may be triggered in response to pre-defined values of predictions error.

### The UE 105

Some steps performed by the UE 105 with respect to the MPM re-configuration which has already been briefly described above will now be described in more details. The re-configuring of the MPM at the UE 105 may possibly be based on reports that the UE 105 transmits to the network node 101 with information related to the mobility predictions such as the error and/or accuracy of the MPM outputs. The outputs of the MPM comprises predicted mobility related information e.g., predicted RSRP, predicted next cell the UE 105 is moving to, etc. Hence, the UE 105 may either be initially configured with at least one MPM, e.g., during connection setup and/or establishment, and/or has an MPM as a software function, e.g., if that is implemented at the UE 105, that is re-configured and/or updated. Examples of parameters of the MPM that may be re-configured are provided below, such modifying, adding, releasing the weights of an MPM based on neural network, how far in the future predictions should be performed, e.g., at to, predictions at t0+T wherein T is the configurable and/or re-configurable value.

The report of the mobility predictions in step 202 may comprise information related to the MPM that indicates an MPM performance metric, indicating how good and/or how poor the MPM's performance is.

The UE 105 may determine, e.g., measure, calculate, derive, compute etc., information to be comprised in the report in step 202 in FIG. 3, e.g., information related to the MPM, such as an error metric and/or an accuracy metric of the MPM. That may be configured to be reported by the UE 105 to the network node 101. Examples of error and/or accuracy metrics are provided later.

In step 205 in FIG. 3, the UE 105 performs the MPM re-configuration. The MPM re-configuration may be based on the report in step 202 in FIG. 3. In other words, re-configuration of an MPM by the UE 105 in RRC_CONNECTED being received in response or after the transmission of to the UE 105 having transmitted one of the following to the network node 101:
measurement report sent by the UE 105, e.g., RSRP, RSRQ, SINR from a serving and/or neighbor cell; and/or
a report comprising information related to the MPM, possibly comprising error and/or accuracy of the MPM sent by the UE 105.

The re-configuration of the MPM at the UE 105 in RRC_CONNECTED may be performed during a mobility procedure e.g., during a handover, or reconfiguration with sync, Primary Serving cell (PScell) change, PScell addition, when the UE 105 applies an RRC Reconfiguration prepared by a target gNodeB 101 during any of these procedures. The MPM re-configuration, e.g. new settings, parameters, field and/or delta configuration to be applied on top of UE's 105 existing MPM configuration, may be prepared by the target network node 101, possibly based on MPM information indicated from the source network node 101,
e.g. in the case of a handover: in a handover request message or any other message from source network node 101 to target network node 101 during a handover and/or mobility preparation;
in the case of a PSCell addition: in a Secondary Node (SN) Addition Request;
in the case of an SN-initiated PSCell change:
   in a SN Change Required from Secondary Node (SN) to Master Node (MN), etc.

The UE 105 may, based on a result of the mobility predictions in step 201, e.g., referred to as information related to the MPM, perform at least one of the following actions:
Continue performing predictions according to the MPM based on a rule. The rule may be for example the following: if the error of the MPM is lower than a configured or pre-determined threshold or if the accuracy is higher, continue performing predictions based on the MPM. This may be beneficial even if the network node 101 is able to compute and/or calculate the MPM error and/or accuracy, as the UE 105 may use its own calculation to take actions without the need for network signaling for that. There may be additional configurations such as hysteresis and/or time to trigger like parameter: a given MPM error only trigger the action if that is a stable error, to avoid triggering the action due to a single and/or too few mistakes.
Stop performing mobility predictions according to the MPM if the error is higher or the accuracy is lower than a given threshold. The threshold may e.g., be configured by the network node 101.
Make that error available so that it is comprised in a measurement report when that triggered.
Make that error available so that it is comprised in a prediction report when that is triggered.

The actions performed by the UE 105 may be referred to as autonomous actions. The actions may be autonomous in the sense that they are performed as a result of mobility predictions that the UE 105 has performed itself.

The information related to the MPM indicates an MPM performance metric, indicating how good and/or how poor the MPM's performance is.

### The Network Node 101

Some steps performed by the network node 101 with respect to the MPM re-configuration which has been briefly described above will now be described in more detail. The network node 101, referred to as a network element may be for example a gNodeB, enodeB, a core network function etc. The network node 101 enables or handles re-configuring a MPM at the UE 105, possibly based on reports received from the UE 105 comprising information related to the MPM, such as the error and/or accuracy of the MPM outputs, e.g., predicted mobility related information e.g., predicted RSRP, predicted next cell, etc. The network node 101 may determine to re-configure the MPM based on information the network determines, derives, calculates from or based on the MPM, such as the network's estimation of a MPM error and/or accuracy e.g., if the network node 101 has available information on a predicted value and real value. The network node may transmit an RRC Reconfiguration message to perform the UE's MPM re-configuration and/or update. If the network node 101 is capable of calculating the information related to the MPM, such as the error and/or accuracy of the MPM outputs, the network node 101 may have its own rule to base on that activates and/or deactivates the UE 105 to perform predictions or not.

The MPM performance metric indicates how good and/or how poor the MPM's performance is. The network node 101 may derive, compute, calculate the information related to the MPM e.g., a performance metric for the MPM, like the MPM error and/or accuracy. Another solution may be that the network node 101 receives the information related to the MPM's performance from the UE 105.

The network node 101 may configure the UE 105 for measuring, calculating, deriving information related to the MPM, such as an error metric and/or an accuracy metric of the MPM. The network node 101 may configure the UE 105 to report the information related to the MPM e.g., based on configured rules.

The network node 101 may re-configure an MPM at the UE 105 in RRC_CONNECTED in response or after having received from the UE 105 one of the following:
measurement report sent by the UE 105, e.g., RSRP, RSRQ, SINR from a serving and/or neighbor cell; and/or
a report related to the MPM, possibly comprising error and/or accuracy of the MPM sent by the UE 105.

The network node 101 may determine to re-configure the MPM based on the triggering, preparation and/or execution of a mobility procedure, e.g., reconfiguration of the MPM performed as part of mobility preparation, mobility execution, etc. A mobility procedure may correspond to a handover, reconfiguration with sync, PSCell change, PSCell addition, etc. The decision may be performed by a serving and/or source network node or element, e.g., source gNodeB. The serving and/or source network node, e.g., S-gNodeB, may send information related to the MPM to a target network node and/or element, e.g., the target gNodeB, and the current MPM configuration, and in response the target network node and/or element may determine to re-configure the MPM upon the handover, e.g., by modifying and/or releasing and/or adding at least a parameter, field or information element related to the MPM, and transmits the re-configuration of the MPM to the source network node 101. The source network node 101 may send the re-configuration of the MPM to the UE 105. The information related to the MPM from the source network node 101 to the target network node 101 may either be information reported from the UE 105, and/or calculated by the source network node.

The network node 101 may configure the UE 105, based on the information related to the MPM, to perform at least one of the autonomous actions described above.

The further details of the following steps will now be provided, described as follows:
Configuring the UE with an MPM.
Determining mobility prediction error.
Providing a report from the mobility prediction.
Performing actions.
Re-configuring the MPM.
   Configuring the UE 105 with an MPM

This step is illustrated for example in step 401 of FIG. 4 and is a pre-requisite in FIG. 3 even though it is not explicitly illustrated here. The UE 105 may initially be configured, e.g., by the network node 101, with an MPM. Initially the UE 105 is configured with an MPM when no MPM is previously configured, for example, when the UE 105 transitions to RRC_CONNECTED coming from RRC_IDLE. The MPM which the UE 105 is initially configured with, i.e., before step 201 in FIG. 3 and in step 401 of FIG. 4, may be referred to as an initial MPM, a first MPM, a current MPM, etc.

A UE 105 may be configured by the network node 101 with an MPM upon the occurrence of an event, e.g., handover, mobility, reconfiguration with sync, PSCell addition, PScell change, beam failure detection, beam failure recovery, Radio Link Failure (RLF) re-establishment, connection setup, transition from RRC_IDLE to RRC_CONNECTED, when the UE 105 is turned on or when the UE 105 is registered to the network.

The MPM may be implemented as a software function that is provided from the network node 101 to the UE 105, for example, in a procedure where the UE 105 downloads this software function, e.g., from a server in the communications system 100.

The UE 105 may indicate to the network node 101, a capability signalling indicating that it implements a given MPM and/or that it supports a given type of MPM, e.g. based on Neural Networks, and/or that it supports a given configuration of an MPM, e.g. maximum number of Neural Network branches, and/or the type of input the model takes into account, e.g., sensor information, etc.

The model and/or parameters of the MPM initially configured and/or re-configured may be part of an RRC message, such as RRC Reconfiguration message, e.g., handover (HO) command, RRCReconfiguration, or RRC Connection Setup when entering in RRC_CONNECTED.

A UE 105 may declare a failure, e.g., a reconfiguration failure, if the network node 101 tries to configure it with an MPM that it does not support and/or with a configuration of an MPM that it does not support. Alternatively, the UE 105 may indicate to the network node 101, e.g., in an RRC Reconfiguration Complete message, that it does not support the MPM that the network node 101 has tried to configure the UE 105 with.

The UE 105 may be configured with more than one MPM, possibly for a similar purpose, wherein these may differ depending on a feature, e.g., network area, cell, set of beams, SSBs, frequency, frequency range, etc. The UE 105 may receive an indication for activating at least one of the configured MPM(s). For example, there may be different MPMs for different frequency ranges (FRs) e.g., FR1 has MPM-fr1 and FR2 has MPM-fr2.

Each MPM may have an associated condition that activates them. For example, when the UE 105 connects to a network node 101, e.g., a gNB, the network node 101 may send multiple MPMs corresponding to different cells mounted on the network node 101. The UE 105, upon HO to a cell, activates the associated MPM.

The activation condition for the stored MPMs may be error and/or accuracy levels of the MPMs.

Another activation condition may be activation of a network feature such as carrier aggregation/dual connectivity (CA/DC).

The UE 105 may have, i.e., implement, at least one MPM that may be configured by the network node 101, e.g., via network signalling, like RRC, Non-Access Stratum (NAS), Over The Top (OTT) or any other protocol that may provide control signalling. That may be an MPM that is standardized in 3GPP or any other standardization body that in order to be used, the UE 105 may need to be activated and/or configured during a procedure such as connection setup, e.g., during transition from RRC_IDLE to RRC_CONNECTED.

This initial MPM may be configured in an RRC Setup message from the network node 101, e.g., source gNodeB, to the UE 105, if the security is not required to be activated for configuring the model, although the report of predictions may only be done after security activation.

The UE 105 may first need to setup security to only then receive the initial MPM configuration.

The UE 105 may be configured with multiple MPM(s). Each MPM has an identifier that may later be used to refer to a given configuration. When the multiple MPM(s) are configured in an RRC message, the UE 105 may receive an indication of which MPM is to be considered initially active, i.e., which one is to be used upon reception of the message.

### Determining Mobility Prediction Error

This step may be part of steps 201 or 203 illustrated in FIG. 3 or it may be steps 403 or 405 illustrated in FIG. 4. This may be an optional step. The step of determining mobility prediction error may be referred to as determining an MPM error.

The UE 105 may determine, e.g., measure, calculate, estimate, derive, create, compute etc. information related to the MPM, such as an error metric and/or an accuracy metric of the MPM. This may be configured to be reported by the UE 105 to the network node 101, e.g., in step 202 in FIG. 3 and in step 404 in FIG. 4. The calculation of an MPM error enables the UE 105 to understand the performance of the MPM, i.e., how accurate the output of the predictions is and/or how large or small the prediction errors are. The determination of the MPM error may enable the UE 105 to possibly take actions such as indicate to the network node 101 so the network node 101 may take further actions, such as re-configure the MPM and/or releasing it and/or prevent taking decisions based on the reported predictions.

As part of step 203 in FIG. 3 and/or step 405 in FIG. 4, there may be a possibility for the network node 101 to determine the MPM error, in addition to the UE 105 or instead of the UE 105.

Regarding the calculation of information related to the MPM, such as the metrics to estimate the prediction error of the MPM:
The UE 105 or the network node 101 may estimate different metrics for evaluating the MPM's prediction error according to which metrics are being predicted, possibly configured by the network node 101, e.g.:
   If the MPM returns as output, for example: i) an index or identifier of a next cell the UE 105 is predicted to move to or enter the coverage of, where the identifier or index may be, e.g., physical cell identity (PCI) and/or Cell Identity as indicated in a System Information Block; ii) the beam or Synchronization Sequence Block (SSB) index or identifier, e.g., that is expected to best serve a UE 105 in the future; the error may be defined as a pre-determined value, e.g., error equals to one, if the prediction was correct and another value, e.g., error equals to zero, if it was wrong. This may be applicable for handovers, and to any reconfiguration with sync, such as PSCell Addition, e.g., where the UE 105 predicts which cell is the one the UE 105 will setup Multi-Radio Dual Connectivity, and PSCell Change.
      For example, this MPM error may be derived or calculated by the UE 105 having performed a mobility prediction at a given point in time, e.g. t0, for a future time, e.g. t0+T, such as predicted target cell being the cell whose PCI=110. After having received a handover command indicating a PCI=X, wherein X is not 110, the UE 105 may derive the error. The reporting of information related to the MPM is described in more details later, and in this case, one option may be that the UE 105 may transmit or report to the target network node 101, e.g. after the handover, mobility, reconfiguration with sync, the information related to the MPM, i.e., the error of the MPM. Then, the target network node 101 may forward to the source network node 101 the error of the MPM, e.g., that has configured the MPM associated to that error being reported. Another option may be that the UE 105 may send the MPM error to the source network node 101, before it leaves and continues with the handover.
   If the MPM returns a measurement prediction value, the error may be, for example:
      The absolute error: UE 105 may perform prediction of a measurement at t=t0 for further time T, e.g., predicted-RSRP-cell-A (t0, T); At t=t0+T, the UE 105 may have that exact measurement available, e.g., RSRP-cell-A (T); then, error=| RSRP-cell-A (T)−predicted-RSRP-cell-A (t0, T)|
      The relative error: relative error=| RSRP-cell-A (T)−predicted-RSRP-cell-A (t0, T)|/| RSRP-cell-A (T)|
      The mean absolute error (MAE), the mean squared error (MSE) and the root mean squared error (RMSE);
         Squared-error metrics tend to penalize large errors heavily, while absolute-error metrics are more robust to single-outlier-error type scenarios.
         Combinations of these metrics are envisioned, for example: β *MSE+(1−β)*MAE, where 0<3<1.
The error may be defined as the average number of wrong predictions over a given duration.
The error may be based on a single, e.g., instantaneous, sample or be filtered, e.g., error_{filtered}^{t}=(1−α)*error_{filtered}^{t-1}+α *errorᵢₙₛₜₐₙₜₐₙₑₒᵤₛ^{t}, where 0≤ α≤1 is a filter coefficient and t is an instant of time.
The reported error may be calculated over a window of time as well. Let M be the length of the time window that the error needs to be calculated, the reported error may be defined as:

$${reported}_{e r r o r}^{t} = \frac{1}{M} {\sum }_{i = 0}^{M - 1} {( {error}^{i} )}^{2}$$

$${reported}_{e r r o r}^{t} = {max}_{0 \leq i \leq M} \vert {error}^{i} \vert$$

The UE 105 may be configured with a buffer or length parameter. The tendency is that error increases as the UE 105 tries to predict mobility related information, e.g., predicted RSRP, RSRQ, further in time. For example, it may be easier to predict RSRP in the next 50 milliseconds than in the next minute. Hence, the error may be calculated for a given length.

The UE 105 may determine, e.g., measure, calculate, derive, create, compute etc., information related to the MPM. The metric derived may reveal the performance of the MPM. In the above, error metrics for the MPM were described, but accuracy metrics may be applicable, e.g., if the MPM provides predictions with 95% accuracy, meaning a 5% error.

As indicated earlier, the network node 101 may be able to determine information related to the MPM. The metric derived may reveal the performance of the MPM. In that case, the network node decisions may be based on its own calculation and/or in addition to the UE reports.

Providing a Report from the Mobility Prediction

This step is illustrated in step 202 in FIG. 3 and in step 404 in FIG. 4. The step may comprise to report a MPM error to the network node 101.

The UE 105 may determine, e.g. measure, calculate, derive, information related to the mobility prediction that has been performed using the MPM. The information related to the mobility prediction may be referred to as information related to the MPM since the mobility prediction is performed using the MPM. The information related to the mobility prediction may be for example an error metric and/or an accuracy metric of the MPM. The information related to the mobility prediction may be configured to be reported by the UE 105 to the network node 101. Any information related to the MPM, e.g., MPM performance, MPM error etc., may be comprised in the information related to the mobility prediction that is reported to the network node 101.

The information related to the mobility prediction, such as the error of the MPM, may be comprised in a measurement report, i.e., if the error of the MPM is available. The UE 105 may determine the MPM error when it is time to transmit a measurement report and/or when the measurement report is triggered, and/or when a measurement is being performed. The error of the MPM may be only comprised if the measurement report comprises predictions of the measurements, wherein the predictions are performed according to the MPM. For example, if the UE 105 is configured to comprise predictions of RSRP for the triggered cells, the UE 105 may have comprised the MPM error for the MPM used for deriving the predictions of RSRP for the triggered cells.

If the measurement configuration comprises an indication, then the UE 105 may comprise the MPM error in the measurement report, wherein that is configured by the network node 101. Instead of reporting an exact value of the MPM error, the UE 105 may indicate in the measurement report that the MPM error is high, by comprising a flag in the report, assuming the network node 101 is aware that the flag means the error is above a certain error value.

There may be a rule indicating that the UE 105 comprises predictions in the measurement report or any other message if the MPM error is below a certain value, pre-defined or configured by the network node 101.

There may be a rule indicating that the UE 105 may stop comprising predictions in the measurement report or any other message if the MPM error is above a certain value. The value may be pre-defined or configured by the network node 101. The MPM error may be reported in a specific report called MPER.

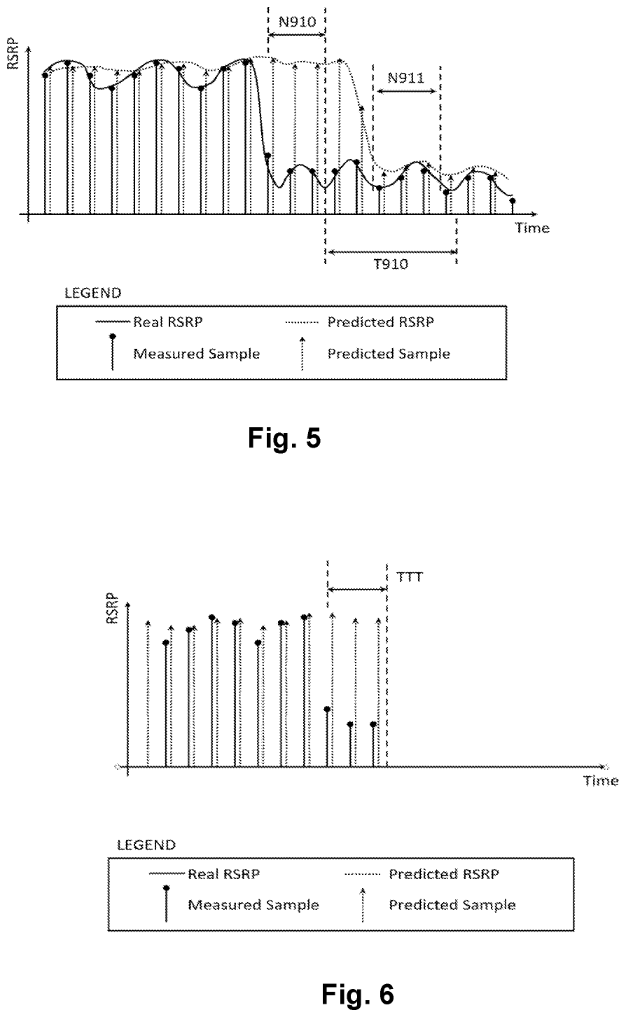

The MPER may be either periodic or triggered by an event. An event may be defined as illustrated in FIG. 5, for the case of the RSRP value being predicted. The x-axis of FIG. 5 represents time and the y-axis represents RSRP. The solid lines represent real RSRP and the dotted lines represent predicted RSRP. The solid arrows represent a measured sample and the dotted arrows represent a predicted sample. The UE 105 may continuously estimate the prediction error. Upon N910 consecutive prediction error measurements higher than a predefined threshold, the UE starts timer T910. If N911 consecutive prediction error measurements are below another threshold prior to the T910 timer expiring, the T910 timer stops. In other words, it may be assumed that the model is recovered, and nothing should be done. Otherwise, the timer expires and the UE 105 may trigger a MPER.

In another option, if the error plus hysteresis is higher than a THRESHOLD for a duration of Time-to-Trigger (TTT), a MPER may be generated comprising the MPM error value or values, e.g., absolute and relative, accuracy, etc. As a way to indicate to the network node 101 that the MPM needs to be re-configured or replaced. An example is illustrated in FIG. 6 for the case of the RSRP value being predicted. The x-axis of FIG. 6 represents time and the y-axis represents RSRP. The solid lines represent real RSRP and the dotted lines represent predicted RSRP. The solid arrows represent a measured sample and the dotted arrows represent a predicted sample.

The error of the MPM may be comprised in an RRC Reconfiguration Complete message after a handover, e.g., in the target cell. Or, an availability indication of the MPM error may be comprised in the RRC Reconfiguration Complete message, so that the MPM error may be retrieved by the network node 101, e.g., as a Self-Organizing Network report, like the retrieval of a Random Access Channel (RACH) report or an RLF report. In that case the UE 105, possibly after the handover, receive a UE Information Request message, for requesting the report of the MPM error, and in response the UE 105 may comprise the MPM related information, e.g., MPM error, in a UE Information Response message. Upon reception, the network node 101 may forward the MPM error to the network node 101 that has configured that MPM, e.g., the source network node in the case of a handover.

There may be events that indirectly imply a possible increase in prediction error for the MPM. Regarding this:
An indication of a failure event may trigger the report of a MPM error. For example, when one or more beam failure instances is received from lower layers, then the report of a MPM error is triggered. Another example may be that a retransmission from Radio Link Control (RLC) layer triggers this.
When a new feature or reconfiguration is received by the UE 105, a MPM error may be reported. For example, when a UE 105 receives reconfiguration for addition, modification or release of a Scell or a certain bearer or (de-)activation of Scell.
A MPM error may be triggered after receiving a command to HO to another cell.

The error report and/or any message the UE 105 may transmit comprising the MPM error, may comprise an MPM identifier and the error value. An MPM identifier may be important for the case where multiple MPM(s) are configured, so that the network node 101 receiving the report is aware about which MPM a reported error refers to.

The MPM error report may comprise the MPM identifier and a flag that recommends the network node 101 to reconfigure the prediction procedure. On top of that a reason for setting the value of the flag may be associated to the report for assisting the network node 101. For example, high error value, UE low battery, velocity very high (implies error) or zero, the UE 105 is motionless so MPM is released for battery saving.

The UE 105 may only comprise a list comprised of the ID of MPMs that have large error values.

### Performing Actions

This step is illustrated in step 406 in FIG. 4. The actions may be referred to as autonomous actions.

The UE 105 may, based on the information related to the MPM, performing at least one of the following actions:
Continue performing predictions according to the MPM based on a rule. The rule may be, for example, the following: if the error of the MPM is lower than a configured or pre-determined threshold or the accuracy is higher, continue performing predictions based on the MPM. This may be beneficial even if the network node 101 is able to compute and/or calculate the MPM error and/or accuracy, as the UE 105 may use its own calculation to take actions without the need for network signalling for that. There may be additional or other configuration such as hysteresis and/or time to trigger like parameter: a given MPM error only triggers the action if that is a stable error, to avoid triggering the action due to a single/too few mistakes.
Stop performing predictions according to the MPM if the error is higher or the accuracy is lower than than a given threshold, e.g., configured by the network node 101.
Make that error available so that it is comprised in a measurement report when that is triggered.
Make that error available so that it is comprised in a prediction report when that is triggered.

The actions the UE 105 may perform may be based on the MPM error level or an event that implies an increase on error level. Some further actions may be:
Deactivation of an MPM. When the UE 105 detects a large error value it may deactivate the predictions altogether, e.g., stop performing predictions and/or stop monitoring conditions that have predictions as input for triggering further actions like a report.
   The UE 105 may be configured by the network node 101 with multiple MPMs, each MPM have specific MPM conditions for its activation. The conditions may have as input at least one indication of the performance of the MPM. If a condition is fulfilled, the UE 105 may activate the respective MPM. For example:
      MPM(1)→condition a;
      MPM(2)→condition b;
      MPM(3)→condition c;
      If condition “b” is fulfilled, the UE 105 may activate MPM(2).
   If the UE 105 has multiple MPMs, it may be assumed that predictions are performed for these different MPMs and different performance indications are being calculated, so the UE 105 may select the MPM providing the best performance e.g., lowest errors.
   The activation condition may relate to speed of the UE 105. The UE 105 may only perform the activation if the velocity is higher than a threshold. The activation condition may be related to the frequency, for example the UE 105 may have utilized the MPM for FR2 but not FR1.
Switching MPMs. The network node 101 may configure the UE 105 with multiple MPMs. For example, the network node 101 may send two MPMs, e.g. MPM(1) and MPM(2), to the UE 105 for performing RSRP predictions. The UE 105 that is running MPM(1) may detect a large error for MPM(1). This error may trigger the UE 105 to switch to MPM(2) to perform predictions.
   The UE 105 may switch MPMs based on other triggering events, such as: when transitioning states, e.g., going to IDLE state; upon HO; upon serving beam/SSB change; upon position change, e.g., there may be different MPMs for cell border and cell center.
A large error may trigger the UE 105 to re-train the model to improve and reduce the error.
Releasing models.
Stop reporting predictions based on MPMs whose error is above a pre-configured threshold.
Stop performing predictions based on MPMs whose error is above a pre-configured threshold.
Any combination of the above actions may be possible as well.

### Re-Configuring the MPM

This step is illustrated in steps 204 and 205 in FIG. 3 and in step 407 in FIG. 4. The step may comprise the UE 105 receiving a new set of parameters to re-configure the MPM.

The MPM is re-configured by the UE 105, possibly based on reports the UE 105 transmits to the network with information related to the MPM, such as the error and/or accuracy of the MPM outputs, e.g., predicted mobility related information, e.g., predicted RSRP, predicted next cell, etc. Hence, the UE 105 may be either initially configured with at least one MPM, e.g., during connection setup and/or establishment, and/or has an MPM as a software function, e.g., if that is implemented at the UE 105.

The reconfiguration of an MPM may comprises updating the parameters of the specific AI/ML model used by the UE 105. For example, if a deep neural network (DNN) is used for the MPM, the parameters that may be re-configured may be new weights associated to the layers and neurons comprising activation functions, wherein neurons and layers are referred in the DNN literature. The network node 101 may change the number of layers and neurons in the MPM.

The reconfiguration of an MPM may comprise the modification of the type of ML method. For example, UE 105 may be configured by the network node 101 with a different type of ML method, compared to the current type of ML method for the MPM the UE 105 has. Or, the network node 101 may change a DNN model with a recurrent neural network (RNN).

The network node 101 may re-configure the MPM to make predictions based on different features, i.e., features may be added, removed, modified in the reconfiguration. For example, the UE 105 may operate in a low frequency range and only uses current RSRP values to predict future RSRP values and is handed over to another cell high frequency range and the network node 101 may re-configure the UE 105 to use both current RSRP values and location information for a more accurate predictions, and/or sensor information. The network node 101 may consider UE capabilities to select features to re-configure the MPMs.

The network node 101 may configure the UE 105 to predict with different outputs. For example, the UE 105 may be configured to predict the next beam, e.g. SSB index in the cell. Then the UE 105 may be handed over to another cell with a single beam (SSB) and the network node 101 may configure the UE 105 with a new MPM for predicting the next cell.

The network node 101 may configure the MPM with a different granularity of input data and outputs. For example, the UE 105 may use [RSRP(t-nT), RSRP(t-(n-1)T, . . . , RSRP(t)] to generate a prediction of the form [RSRP(t), RSRP(t+T), . . . , RSRP(t+mT)]. The network node 101 may configure the UE 105 with different granularities with [RSRP(t-jT), . . . , RSRP(t)] as input to predict [RSRP(t), RSRP(t+T), . . . , RSRP(t+KT)].

Based on a received prediction and a measurement report and/or a report of a MPM error from a UE 105, the network node 101 may decide whether or not it is necessary and/or recommended to re-configure the MPM used by a UE 105.

If the network node 101 does not receive a report of a MPM error from a UE 105, it may determine, e.g., estimate, the MPM error based on the received prediction and on the received measurement report.

The network node 101 may check in a predefined list what actions should be taken in case the MPM error is higher than a predefined threshold.

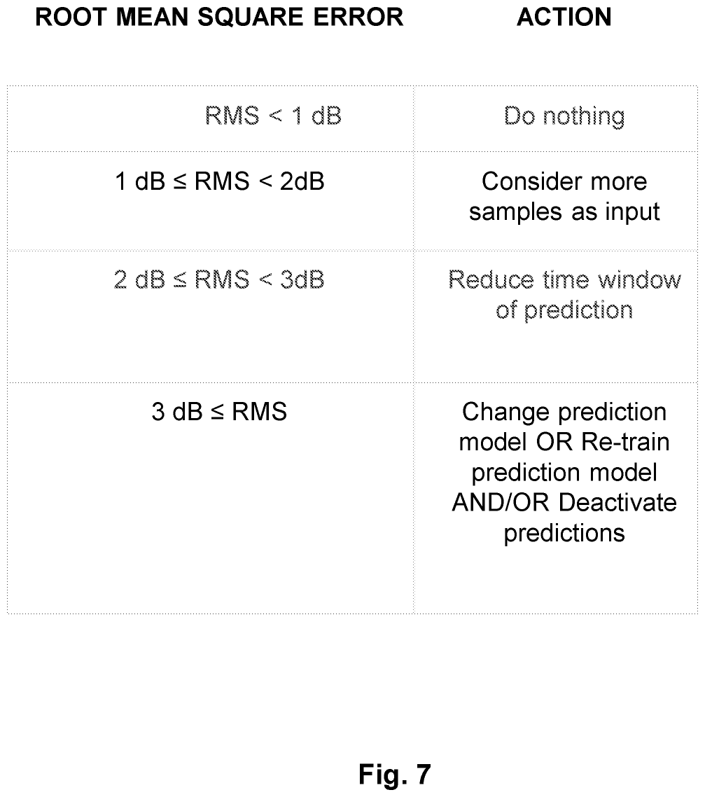

FIG. 7 illustrates a table with examples of thresholds and actions. The actions may be based on root mean square error. The left column represents the thresholds, and the right column represents the actions. For example, if reported RMS error is lower than 1 dB, no action should be taken. If the reported RMS error is between 1 dB and 2 dB, the network node 101 may configure the UE 105 to take into account more samples as input in order to better model a channel measurement time evolution. If the reported RMS error is between 2 dB and 3 dB, the network node 101 may configure the UE 105 to reduce the time window of predictions, i.e., predict samples in a shorter time window. If the reported RMS error is higher than or equal to 3 dB, the network node 101 may either change the consider prediction model or forces the UE 105 to re-train it or even deactivate predictions.

While a UE 105 is in connected mode, e.g. RRC_CONNECTED mode, it may receive a message from the network node 101, e.g. RRCReconfiguration, to re-configure the MPM. That may comprise at least the UE 105 re-configuring at least one parameter, field or Information Element (IE) of the MPM.

The re-configuration procedure may be one or more of:
A modification of the MPM configuration using delta signalling, wherein a subset of the MPM parameters is/are modified, e.g., according to the need codes, e.g., code M, defined for these parameters; and/or
A replacement, i.e., the stored set of the MPM's parameters are replaced by a new set of parameters; and/or
An indication that a pre-stored MPM is to be used by the UE 105. The UE 105 may have configured multiple MPM, each associated to an MPM identifier; and/or
A release of the MPM configuration, by referring to an MPM identifier that has been previously configured e.g. as in an AddMod and/or Release list structure.

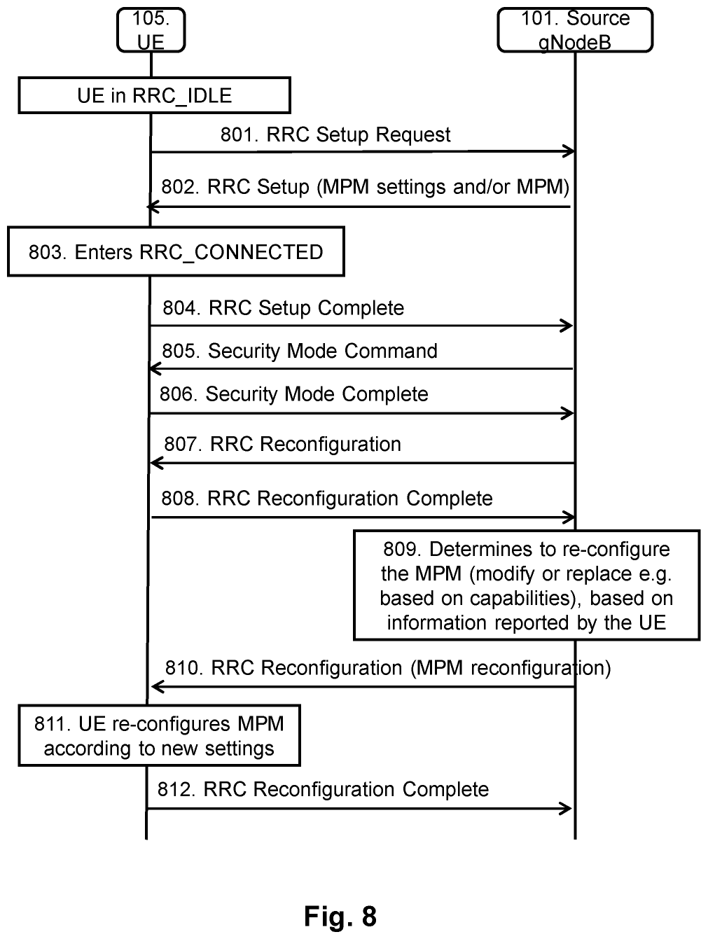

The MPM re-configuration procedure as described above may be triggered in response, e.g., by a network node 101 to the UE 105, to one or more of the following:
The report by the UE 105 of an error related information of the MPM, and/or an accuracy related information of the MPM. Upon receiving the MPM re-configuration, the UE 105 may perform some clean up actions related to the previous MPM configuration such as deleting and/or releasing entries predicted according to the previous model, state variables, reset timers, etc. FIG. 8 is a signalling diagram illustrating this and FIG. 8 will be described in more detail below.
The network node detection of a condition based on an error related information of the MPM, e.g., and/or an accuracy related information of the MPM, wherein that is monitored by the network node 101, i.e., instead of being reported by the UE 105. The network node 101 may monitor the predicted mobility related information that is being reported and compares with real measurement reports, e.g., triggered by an A3 event, to determine some error related information for the MPM. Hence, in other words, it may be considered that the MPM re-configuration procedure may be received by UE 105 from the network node 101 in response, e.g., to the transmission of a measurement report by the UE 105 to the network node 101.

FIG. 8 will now be described in more detail. In FIG. 8, the network node 101 is exemplified by a source gNodeB but any other suitable type of network node 101 is equally applicable. FIG. 8 illustrates the UE MPM re-configuration assisted by the network node 101 based on information reported by a UE 105 comprises. At start of the method, i.e., before step 801 is performed, the UE is in RRC_IDLE mode. The method in FIG. 8 comprises at least one of the following steps, which steps may be performed in any suitable order than described below:

### Step 801

The UE 105, which is in RRC_IDLE mode, sends a RRC Setup Request to the source gNodeB 101.

### Step 802

The source gNodeB 101 sends a RRC setup message to the UE 105. The RRC setup message comprises MPM settings and/or MPM.

### Step 803

The UE 105 enters RRC_CONNECTED mode.

### Step 804

The UE 105 sends a RRC Setup Complete message to the source gNodeB 101.

### Step 805

The source gNodeB 101 sends a security mode command to the UE 105.

### Step 806

The UE 105 sends a security mode complete message to the source gNodeB 101.

### Step 807

The source gNodeB 101 sends a RRC Reconfiguration message to the UE 105.

### Step 808

The UE 105 sends a RRC Reconfiguration complete message to the source gNodeB 101.

### Step 809

The source gNodeB 101 determines to re-configure the MPM, i.e., to modify or replace based on, for example, capabilities or information reported by the UE 105.

### Step 810

The source gNodeB 101 sends a RRC Reconfiguration message to the UE 105. The RRC Reconfiguration message comprises the MPM reconfiguration.

### Step 811

The UE 105 reconfigures the MPM according to the new settings, i.e., according to what was received in step 810.

### Step 812

The UE 105 sends a RRC Reconfiguration Complete message to the source gNodeB 101.

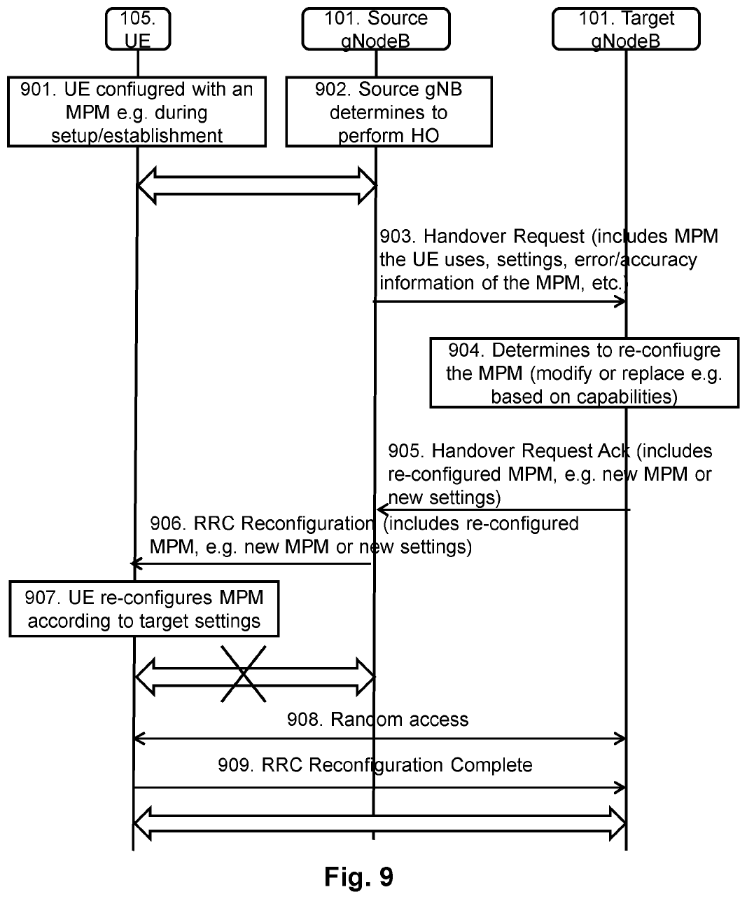

The MPM at the UE 105 may be re-configured during a mobility procedure, e.g., during a handover, PSCell change, inter-cell mobility, reconfiguration with sync. In other words, as the UE 105 moves from one cell to another, i.e., performs an inter-cell mobility and/or handover and/or cell change and/or re-configuration with sync, the network node 101 may determine whether an MPM re-configuration is required or not. If the target cell for mobility is in a different network node 101 than the source network node 101, i.e., the network node 101 the UE 105 is currently connected to, e.g., target network node 101 which controls the target cell, the target network node 101 may select a MPM based on UE capabilities, and configures that model in the HO command, e.g., in an RRC Reconfiguration message, the UE 105 may receive from the source network node 101, e.g., source gNodeB, and may apply during the mobility procedure, e.g., handover. The UE 105 may apply the configuration and start to use the newly configured MPM in the target cell. Upon receiving the MPM re-configuration, the UE 105 may perform some clean up actions related to the previous MPM configuration such as deleting and/or releasing entries predicted according to the previous model, state variables, reset timers, etc. An example is shown in FIG. 9.

In FIG. 9, one network node 101 is exemplified with a source gNodeB and another network node 101 is exemplified with a target gNodeB 101, but any other suitable type of network nodes 101 are equally applicable. At start of the method, the UE 105 is connected to and served by the source gNodeB 101. FIG. 9 illustrates an example of signalling for UE MPM re-configuration assisted by the network node 101 during a mobility procedure, e.g. a handover. The method in FIG. 9 comprises at least one of the following steps, which steps may be performed in any suitable order than described below:

### Step 901

The UE 105 is configured with an MPM, e.g. during setup or establishment.

### Step 902

The source gNodeB 101 determines to perform HO.

### Step 903

The source gNodeB 101 sends a Handover Request message to the target gNode B 101, i.e., the network node 101 to which the UE 105 is to be handed over. The Handover Request message comprises the MPM the UE 105 currently uses, settings, error information of the MPM, accuracy information of the MPM etc.

### Step 904

The target gNodeB 101 determines to re-configure the MPM, e.g., to modify or replace, e.g., based on capabilities.

### Step 905

The target gNodeB 101 sends a Handover Request Acknowledgement message to the source gNodeB 101. The Handover Request Acknowledgement message comprises a re-configured MPM, e.g., new MPM or new settings.

### Step 906

The source gNodeB 101 sends a RRC Reconfiguration message to the UE 105. The RRC Reconfiguration message comprises the re-configured MPM, e.g. the new MPM or the new settings.

### Step 907

The UE 105 re-configures the MPM according to the settings from step 906.

### Step 908

A Random Access procedure between the UE 105 and the target gNodeB 101 is performed.

### Step 909

The UE 105 sends a RRC Reconfiguration Complete message to the target gNodeB 101. As shown in FIG. 9, in the case of an inter-node procedure, the Handover Request message from the source gNodeB 101 to the target gNodeB 101 (step 903) may comprise information related to the error and/or accuracy of the MPM, wherein that may have been obtained by the source gNodeB 101 from the UE 105, e.g. via a reporting of the information related to the error and/or accuracy of the MPM. The information may be used as input by the target gNodeB 101 to determine whether during the handover the MPM is to be re-configured, released or replaced. The Handover Request message from the source gNodeB 101 to the target gNodeB 101 may comprise further information such as reported RSRP, RSRQ and SINR measurements and/or mobility prediction related information, possibly reported by the UE 105 or predicted by the network node 101, which may be used as input by the target such as predicted RSRP, predicted RSRQ, predicted SINR.

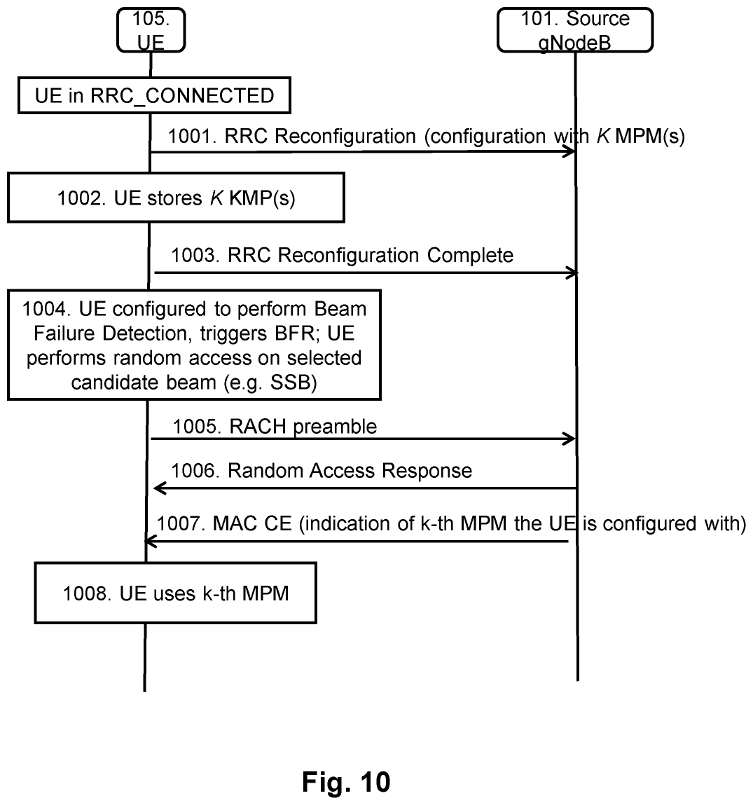

The MPM at the UE 105 may be re-configured during a beam failure recovery (BFR) procedure. In other words, as the UE 105 moves, even within the same cell, and declares BFR, the UE 105 may trigger a random access (step 908) associated to a configured candidate beam, e.g., candidate SSB and/or candidate CSI-RS, and it may receive in response from the network node 101 a message for the MPM re-configuration. That message may be a Medium Access Control protocol (MAC) Control Element (CE) associated to a logical channel Identifier (LCID) indicating a value associated to an MPM identifier associated to one of the MPM(s) stored at the UE 105. In another alternative, that message may be an RRC Reconfiguration message as described earlier. In another alternative, upon BFR the UE 105 may transmit to the network node 101 a BFR MAC CE comprising information associated to candidate beams and possibly comprising MPM related information, such as the error and/or accuracy related information, so that the network node 101 may select a new MPM based on that report. An example is shown in FIG. 10.

FIG. 10 shows an example of signalling for UE MPM re-configuration assisted by the network node 101 during a beam failure recovery procedure. In FIG. 10, the network node 101 is exemplified with a source gNodeB, but any other suitable type of network nodes 101 are equally applicable. At start of the method, the UE 105 is in RRC_CONNECTED mode. The method in FIG. 10 comprises at least one of the following steps, which steps may be performed in any suitable order than described below:

### Step 1001

The source gNodeB 101 sends a RRC Reconfiguration message to the UE 105. The RRC Reconfiguration message comprises a configuration with K MPM(s), where K is a positive integer.

### Step 1002

The UE 105 stores the K MPM(s).

### Step 1003

The UE 105 sends a RRC Reconfiguration Complete message to the source gNodeB 101.

### Step 1004

The UE 105, which is configured to perform Beam Failure Detection, triggers the BRF. The UE 105 performs random access on selected candidate beams, e.g., SSB.

### Step 1005

The UE 105 sends a RACH preamble message to the source gNodeB 101.

### Step 1006

The source gNodeB 101 sends a Random Access Response message to the UE 105.

### Step 1007

The source gNodeB 101 sends a MAC CE message to the UE 105. The MAC CE message comprises an indication of the k-th MPM which the UE 105 is configured with, where k is a positive integer.

### Step 1008

The UE 105 uses the k-th MPM.

The MPM at a UE 105 may be reconfigured based on another UE's report. For example, UE1 send a measurement report to the network node 101 indicating that MPM1 has a high error value. The network node 101, based on this report, may decide to reconfigure the MPM1 of all the UEs 105 in the same cell as UE1.

The network node 101 may modify SI based on an MPM error. For example, if the prediction model is broadcasted in SIB ‘n’ and a UE 105 in the coverage of SIB ‘n’ reports a high level of error, the network node 101 may deactivate the MPM broadcast in SI until it re-trains the model.

The network node 101 receiving the MPM error report or detecting an MPM error report may trigger an error report to another network node 101 that uses the same MPM.

The UE 105 may be configured with Multi-Radio Dual Connectivity. For each cell group the UE 105 is configured with, the UE 105 may have an MPM, e.g., MPM for Master Cell Group (MCG), MPM for Secondary Cell Group (SCG). Each MPM configuration may be part of the UE's measurement configuration for the MCG and the SCG respectively.

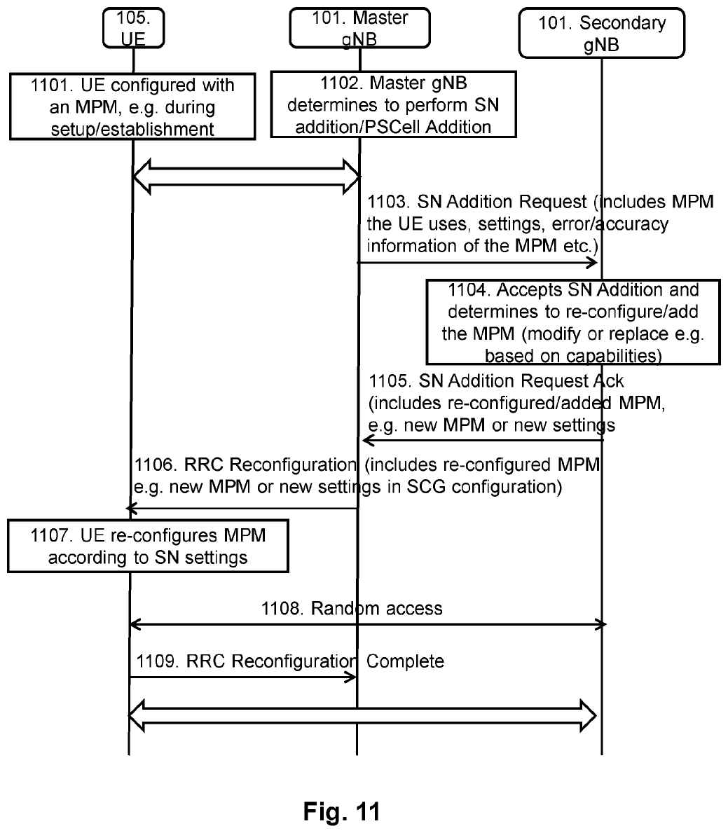

FIG. 11 illustrates a MR-DC scenario. In FIG. 11, one network node 101 is exemplified with a master gNB 101 and another network node 101 is exemplified with a secondary gNB 101, but any other suitable type of network nodes 101 are equally applicable. The method in FIG. 11 comprises at least one of the following steps, which steps may be performed in any suitable order than described below:

### Step 1101

The UE 105 is configured with an MPM, e.g., during setup or establishment.

### Step 1102

The master gNB 101 determines to perform a SN addition procedure or a PSCell addition procedure.

### Step 1103

The master gNB 101 sends a SN Addition Request message to the secondary gNB 101. The SN Addition Request message comprises information indicating the MPM the UE 105 currently uses, settings, error information of the current MPM, accuracy information about the currently used MPM etc.

### Step 1104

The secondary gNB 101 accepts the SN Addition and determines to re-configure or add the MPM, e.g., modify or replace, e.g., based on capabilities.

### Step 1105

The secondary gNB 101 sends a SN Addition Request Acknowledgement message to the master gNB 101. The SN Addition Request Acknowledgement message comprises the re-configured or added MPM, e.g. a new MPM or new settings.

### Step 1106

The master gNB 101 sends a RRC Reconfiguration message to the UE 105. The RRC Reconfiguration message comprises re-configured MPM, e.g. a new MM or new settings in SCG configuration.

### Step 1107

The UE re-configures or adds SCG MPM according to the SN settings.

### Step 1108

The UE 105 and the secondary gNB 101 performs a Random Access procedure.

### Step 1109

The UE 105 sends a RRC Reconfiguration Complete message to the master gNB 101.

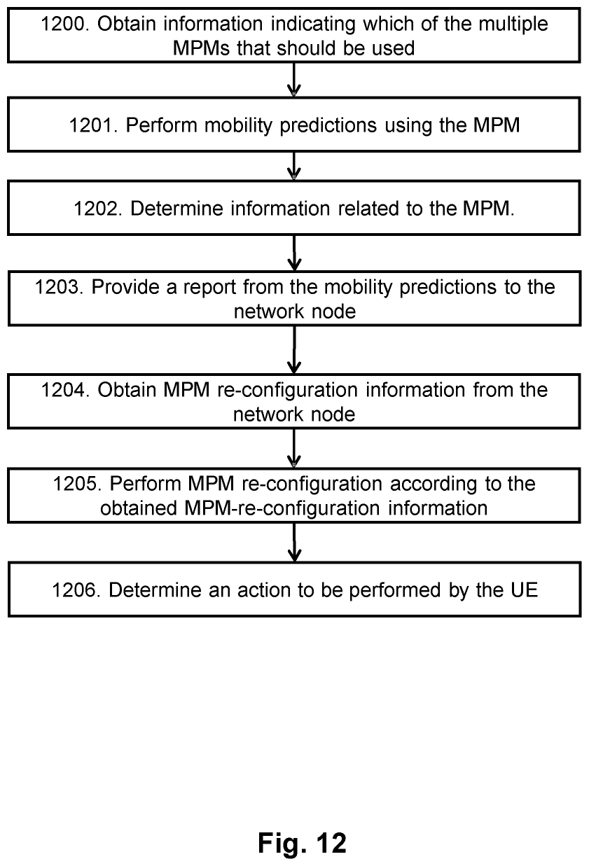

The method described above will now be described seen from the perspective of the UE 105. FIG. 12 is a flowchart describing the present method in the UE 105 for handling MPM re-configuration in a communications system 100. The UE 105 is configured with an MPM. The UE 105 may be in RRC_CONNECTED mode when the method in FIG. 12 is performed. The method comprises at least one of the following steps to be performed by the UE 105, which steps may be performed in any suitable order than described below:

### Step 1200

This step corresponds to step 1007 in FIG. 10. The UE 105 may be configured with multiple MPMs, e.g., at least a first MPM and a second MPM. The UE 105 may obtain, from the network node 101, information indicating which of the multiple MPMs that should be used.

### Step 1201

This step corresponds to step 201 in FIG. 3 and step 402 in FIG. 4. The UE 105 performs mobility predictions using the MPM. The MPM is the one which the network node 101 has configured the UE 105 with, it may be a first MPM, an initial MPM, a current MPM etc.

### Step 1202

This step corresponds to step 403 in FIG. 4. Step 1202 may be a substep of step 1203 or an independent step performed between step 1200 and 1203. The UE 105 may determine the information related to the MPM.

The information related to the MPM may comprise at least one of:
a measurement report comprising a result of the performed mobility predictions, e.g., predicted RSRP, predicted RSRQ, predicted SINR, next cell or beam, SSB, CSI-RS the UE 105 is moving to and/or entering the coverage of, etc.; and/or
MPM error information associated with the use of the MPM in the mobility predictions, e.g., an error metric; and/or
MPM accuracy information associated with the use of the MPM in the mobility predictions, e.g., an accuracy metric; and/or
MPM performance information associated with the use of the MPM in the mobility predictions, e.g., a performance metric; and/or
any combination of the above.

### Step 1203

This step corresponds to step 202 in FIG. 3 and step 404 in FIG. 4. The UE 105 provides a report from the mobility predictions to the network node 101.

The report from the mobility predictions may comprise at least one or both of:
a measurement report comprising a result of the performed mobility predictions, e.g., predicted RSRP, predicted RSRQ, predicted SINR, next cell or beam, SSB, CSI-RS the UE 105 is moving to/entering the coverage of, etc.; and/or
information related to the MPM used in the mobility predictions.

The information related to the MPM may comprise at least one of:
a measurement report comprising a result of the performed mobility predictions, e.g., predicted RSRP, predicted RSRQ, predicted SINR, next cell or beam, SSB, CSI-RS the UE 105 is moving to/entering the coverage of, etc.; and/or
MPM error information associated with the use of the MPM in the mobility predictions, e.g., an error metric; and/or
MPM accuracy information associated with the use of the MPM in the mobility predictions, e.g., an accuracy metric; and/or
MPM performance information associated with the use of the MPM in the mobility predictions, e.g., a performance metric; and/or
any combination of the above.

### Step 1204

This step corresponds to step 204 in FIG. 3, step 407 in FIG. 4, step 810 in FIG. 8, step 906 in FIG. 9 and step 1106 in FIG. 11. The UE 105 obtains MPM re-configuration information from the network node 101.

The MPM re-configuration information may comprise one of:
an updated and/or modified MPM; and/or
another and/or new second MPM; and/or
information indicating a switch from the MPM or the current MPM to another MPM with which the UE 105 is already configured with; and/or
information indicating deactivation of the mobility predictions; and/or any combination of the above.

### Step 1205

This step corresponds to step 205 in FIG. 3, step 811 in FIG. 8, step 907 in FIG. 9 and step 1107 in FIG. 11. The UE 105 performs MPM re-configuration according to the obtained MPM-re-configuration information

Performing the MPM re-configuration may comprise at least one of:
updating and/or modifying the MPM, e.g., updating and/or modifying MPM parameters comprised in the MPM; and/or
replacing the MPM with another/new MPM; and/or
switching from the MPM to another MPM with which the UE 105 is already configured with; and/or
deactivation of the mobility predictions; and/or
any combination of the above.

The re-configuration may be performed during a mobility procedure, e.g., during a handover, PSCell change, inter-cell mobility, reconfiguration with sync, or during a BFR procedure.

### Step 1206

This step corresponds to step 406 in FIG. 4. This step may be performed at any suitable time after step 1202 has been performed, i.e., after the information related to the MPM has been determined. Based on at least a part of the information related to the MPM, the UE 105 may determine an action to be performed by the UE 105.

The action to be performed may be at least one of:
continue to perform mobility predictions using the MPM, i.e., the currently used MPM; and/or
stop performing predictions using the MPM; and/or
providing MPM error information to the network node 101; and/or
deactivating the MPM; and/or
switching to use another MPM instead of the MPM; and/or
re-train the MPM; and/or
release the MPM; and/or
stop providing information related to the MPM to the network node 101; and/or
any combination of the above.

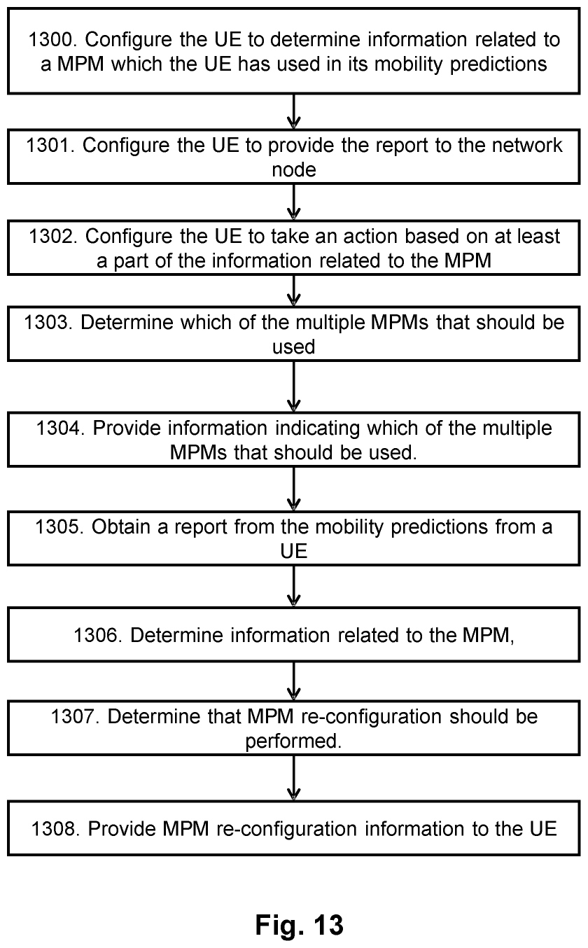

The method described above will now be described seen from the perspective of the network node 101. FIG. 13 is a flowchart describing the present method in the network node 101 for handling MPM re-configuration in a communication system 100. The UE 105 is configured with an MPM. The network node 101 may be one of: a gNodeB, eNodeB, a core network function, a source network node or a target network node. The method comprises at least one of the following steps to be performed by the network node 101, which steps may be performed in any suitable order than described below:

### Step 1300

The network node 101 may configure the UE 105 to determine information related to a MPM which the UE 105 has used in its mobility predictions.

### Step 1301

The network node 101 may configure the UE 105 to provide the report to the network node 101.

### Step 1302

The network node 101 may configure the UE 105 to take an action based on at least a part of the information related to the MPM.

### Step 1303

The network node 101 may determine which of the multiple MPMs that should be used.

### Step 1304

This step corresponds to step 1007 in FIG. 10. The network node 101 may provide, to the UE 105, information indicating which of the multiple MPMs that should be used.

Steps 1300, 1301, 1302, 1303 and 1304 may be performed in any suitable order. They may all be performed before step 1305, or one or more of them may be performed some time after step 1305 has been performed. Step 1304 may only be performed before step 1303, and not after step 1303.

### Step 1305

This step corresponds to step 202 in FIG. 3 and step 404 in FIG. 4. The network node 101 obtains a report from the mobility predictions from a UE 105.

The report from the mobility predictions may comprise at least one or both of:
a measurement report comprising a result of the performed mobility predictions, e.g., predicted RSRP, predicted RSRQ, predicted SINR, next cell or beam, SSB, or CSI-RS the UE 105 is moving to and/or entering the coverage of, etc.; and/or
information related to the MPM used in the mobility predictions.

The information related to the MPM may comprise at least one of:
a measurement report comprising a result of the performed mobility predictions, e.g., predicted RSRP, predicted RSRQ, predicted SINR, next cell or beam, SSB, or CSI-RS the UE 105 is moving to/entering the coverage of, etc.; and/or
MPM error information associated with the use of the MPM in the mobility predictions, e.g., an error metric; and/or
MPM accuracy information associated with the use of the MPM in the mobility predictions, e.g., an accuracy metric; and/or
MPM performance information associated with the use of the MPM in the mobility predictions, e.g., a performance metric; and/or
any combination of the above.

### Step 1306

The network node 101 may determine information related to the MPM, e.g., based on information in the measurement report.

The information related to the MPM may comprise at least one of:
a measurement report comprising a result of the performed mobility predictions, e.g., predicted RSRP, predicted RSRQ, predicted SINR, next cell or beam, SSB, CSI-RS the UE 105 is moving to and/or entering the coverage of, etc.; and/or
MPM error information associated with the use of the MPM in the mobility predictions, e.g., an error metric; and/or
MPM accuracy information associated with the use of the MPM in the mobility predictions, e.g., an accuracy metric; and/or
MPM performance information associated with the use of the MPM in the mobility predictions, e.g., a performance metric; and/or
any combination of the above.

### Step 1307

This step corresponds to step 203 in FIG. 3, step 809 in FIG. 8, step 904 in FIG. 9 and step 1104 in FIG. 11. The network node 101 determines that MPM re-configuration should be performed.

The MPM re-configuration may be determined based on at least one of:
the obtained report; and/or
triggering, preparation and/or execution of a mobility procedure.

The MPM re-configuration may comprise at least one of:
updating and/or modifying the MPM, e.g., updating and/or modifying MPM parameters comprised in the MPM; and/or
replacing the MPM with another and/or new MPM; and/or
switching from the MPM to another MPM with which the UE 105 is already configured with; and/or
deactivation of the mobility predictions; and/or
any combination of the above.

This step may comprise that the network node 101 determines MPM re-configuration information, and this information is described in more detail in step 1308 below.

### Step 1308

This step corresponds to step 204 in FIG. 3, step 407 in FIG. 4, step 810 in FIG. 8, step 905 and step 906 in FIG. 9 and step 1105 and step 1106 in FIG. 11. The network node 101 provides MPM re-configuration information to the UE 105.

The MPM re-configuration information comprises one of:
an updated and/or modified MPM; and/or
another and/or new second MPM; and/or
information indicating a switch from the MPM and/or current MPM to another MPM with which the UE 105 is already configured with; and/or
information indicating deactivation of the mobility predictions; and/or
any combination of the above.

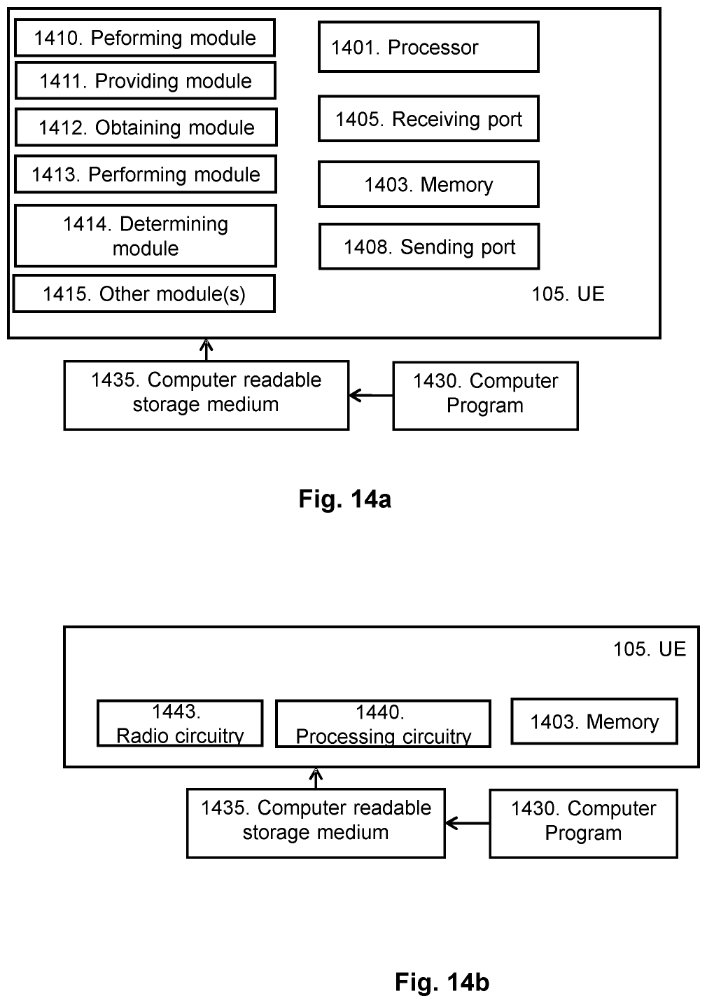

To perform the method steps shown in FIG. 12 for handling MPM re-configuration in a communications system 100, the UE 105 may comprise an arrangement as shown in FIG. 14a and/or FIG. 14b. The UE 105 is arranged to perform the method according to any of the steps in FIG. 12.

FIG. 14a and FIG. 14b depict two different examples in panels a) and b), respectively, of the arrangement that the UE 105 may comprise. The UE 105 may comprise the following arrangement depicted in FIG. 14a.

The present disclosure related to the UE 105 may be implemented through one or more processors, such as a processor 1401 in the UE 105 depicted in FIG. 14a, together with computer program code for performing the functions and actions described herein. A processor, as used herein, may be understood to be a hardware component. The program code mentioned above may be provided as a computer program product, for instance in the form of a data carrier carrying computer program code for performing the present disclosure when being loaded into the UE 105. One such carrier may be in the form of a CD ROM disc. It is however feasible with other data carriers such as a memory stick. The computer program code may be provided as pure program code on a server and downloaded to the UE 105.

The UE 105 may comprise a memory 1403 comprising one or more memory units. The memory 1403 is arranged to be used to store obtained information, store data, configurations, schedulings, and applications etc. to perform the methods herein when being executed in the UE 105.

The UE 105 may receive information from, e.g. the network node 101, through a receiving port 1405. The receiving port 1405 may be, for example, connected to one or more antennas in UE 105. The UE 105 may receive information from another structure in the communications system 100 through the receiving port 1405. Since the receiving port 1405 may be in communication with the processor 1401, the receiving port 1405 may then send the received information to the processor 1401. The receiving port 1405 may be configured to receive other information.

The processor 1401 in the UE 105 may be configured to transmit or send information to e.g. network node 101 or another structure in the communications system 100, through a sending port 1408, which may be in communication with the processor 1401, and the memory 1403.

The UE 105 may comprise a performing module 1410, a providing module 1411, an obtaining module 1412, a, performing module 1413, a determining module 1414, and other module(s) 1415.

Those skilled in the art will appreciate that the performing module 1410, a providing module 1411, an obtaining module 1412, a, performing module 1413, a determining module 1414, and other module(s) 1415 described above may refer to a combination of analogue and digital circuits, and/or one or more processors configured with software and/or firmware, e.g., stored in memory, that, when executed by the one or more processors such as the processor 1401, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 1410-1415 described above may be implemented as one or more applications running on one or more processors such as the processor 1401.

Thus, the methods described herein for the UE 105 may be respectively implemented by means of a computer program 1430 product, comprising instructions, i.e., software code portions, which, when executed on at least one processor 1401, cause the at least one processor 1401 to carry out the actions described herein, as performed by the UE 105. The computer program 1401 product may be stored on a computer-readable storage medium 1435. The computer-readable storage medium 1435, having stored thereon the computer program 1430, may comprise instructions which, when executed on at least one processor 1401, cause the at least one processor 1401 to carry out the actions described herein, as performed by the UE 105. The computer-readable storage medium 1435 may be a non-transitory computer-readable 1430 medium, such as a CD ROM disc, or a memory stick. The computer program 1430 product may be stored on a carrier containing the computer program 1430 just described, wherein the carrier is one of an electronic signal, optical signal, radio signal, or the first computer-readable storage medium 508, as described above.

The UE 105 may comprise a communication interface configured to facilitate communications between the UE 105 and other nodes or devices, e.g., the network node 101, or another structure. The interface may comprise a transceiver configured to transmit and receive radio signals over an air interface in accordance with a suitable standard.

The UE 105 may comprise the following arrangement depicted in FIG. 14b. The UE 105 may comprise a processing circuitry 1440, e.g., one or more processors such as the processor 1401, in the UE 105 and the memory 1403. The UE 105 may comprise a radio circuitry 1443, which may comprise e.g., the receiving port 1405 and the sending port 1408. The processing circuitry 1440 may be configured to, or operable to, perform the method actions according to FIG. 3-FIG. 12, in a similar manner as that described in relation to FIG. 100a. The radio circuitry 1443 may be configured to set up and maintain at least a wireless connection with the UE 105. Circuitry may be understood herein as a hardware component.

Hence, the present disclosure relates to the UE 105 operative to operate in the communications system 100. The UE 105 may comprise the processing circuitry 1440 and the memory 1403. The memory 1403 comprises instructions executable by said processing circuitry 1440. The UE 105 is operative to perform the actions described herein in relation to the UE 105, e.g., in FIGS. 3-12.

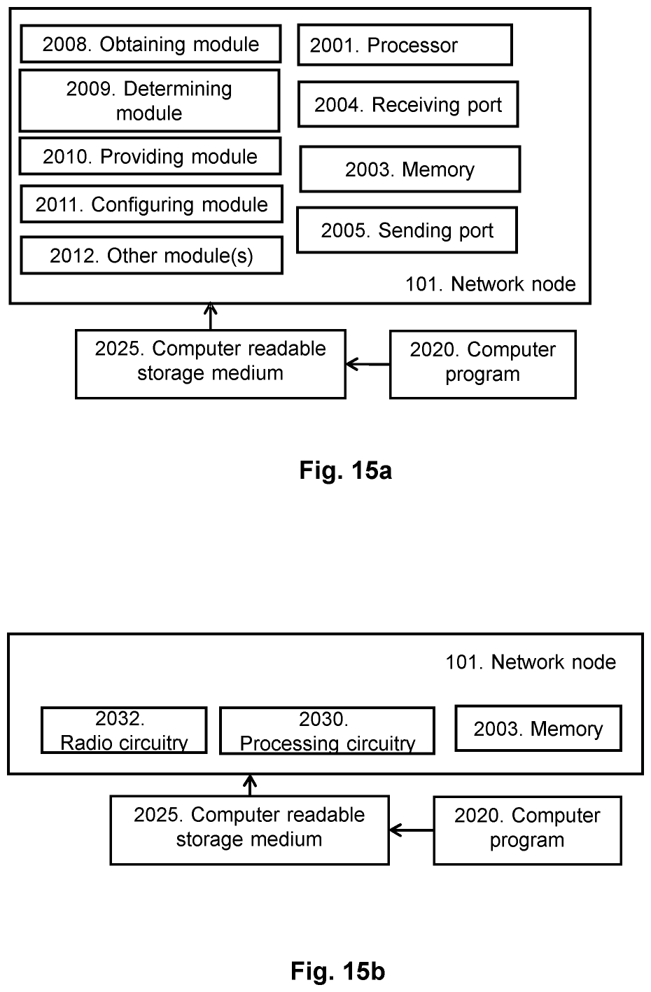

To perform the method steps shown in FIG. 13 for handling MPM re-configuration in a communications system 100, the network node 101 may comprise an arrangement as shown in FIG. 15a and/or FIG. 15b. The network node 101 is arranged to perform the method according to any of the steps in FIG. 13.

FIG. 15a and FIG. 15b depict two different examples in panels a) and b), respectively, of the arrangement that the network node 101 may comprise. The network node 101 may comprise the following arrangement depicted in FIG. 15a.

The present disclosure associated with the network node 101 may be implemented through one or more processors, such as a processor 2001 in the network node 101 depicted in FIG. 15a, together with computer program code for performing the functions and actions described herein. A processor, as used herein, may be understood to be a hardware component. The program code mentioned above may be provided as a computer program product, for instance in the form of a data carrier carrying computer program code for performing the present disclosure when being loaded into the network node 101. One such carrier may be in the form of a CD ROM disc. It is however feasible with other data carriers such as a memory stick. The computer program code may be provided as pure program code on a server and downloaded to the network node 101.

The network node 101 may comprise a memory 2003 comprising one or more memory units. The memory 2003 is arranged to be used to store obtained information, store data, configurations, schedulings, and applications etc. to perform the methods herein when being executed in the network node 101.

The network node 101 may receive information from, e.g., the UE 105, through a receiving port 2004. The receiving port 2004 may be, for example, connected to one or more antennas in network node 101. The network node 101 may receive information from another structure in the communications system 100 through the receiving port 2004.

Since the receiving port 2004 may be in communication with the processor 2001, the receiving port 2004 may then send the received information to the processor 2001. The receiving port 2004 may be configured to receive other information.

The processor 2001 in the network node 101 may be configured to transmit or send information to e.g., the UE 105, or another structure in the communications system 100, through a sending port 2005, which may be in communication with the processor 2001, and the memory 2003.

The network node 101 may comprise an obtaining module 2008, a determining module 2009, a providing module 2010, a configuring module 2011 and other module(s) 2012.

Those skilled in the art will appreciate that the obtaining module 2008, a determining module 2009, a providing module 2010, a configuring module 2011 and other module(s) 2012 etc. described above may refer to a combination of analog and digital circuits, and/or one or more processors configured with software and/or firmware, e.g., stored in memory, that, when executed by the one or more processors such as the processor 2001, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 2008-2012 described above may be implemented as one or more applications running on one or more processors such as the processor 2001.

Thus, the methods described herein for the network node 101 may be respectively implemented by means of a computer program 2020 product, comprising instructions, i.e., software code portions, which, when executed on at least one processor 2001, cause the at least one processor 2001 to carry out the actions described herein, as performed by the network node 101. The computer program 2020 product may be stored on a computer-readable storage medium 2025. The computer-readable storage medium 2025, having stored thereon the computer program 2020, may comprise instructions which, when executed on at least one processor 2001, cause the at least one processor 2001 to carry out the actions described herein, as performed by the network node 101. The computer-readable storage medium 2025 may be a non-transitory computer-readable storage medium, such as a CD ROM disc, or a memory stick. The computer program 2020 product may be stored on a carrier containing the computer program 2010 just described, wherein the carrier is one of an electronic signal, optical signal, radio signal, or the second computer-readable storage medium 2025, as described above.

The network node 101 may comprise a communication interface configured to facilitate communications between the network node 101 and other nodes or devices, e.g., the UE 105, or another structure. The interface may, for example, comprise a transceiver configured to transmit and receive radio signals over an air interface in accordance with a suitable standard.

The network node 101 may comprise the following arrangement depicted in FIG. 15b. The network node 101 may comprise a processing circuitry 2030, e.g., one or more processors such as the processor 2001, in the network node 101 and the memory 2003. The network node 101 may comprise a radio circuitry 2032, which may comprise e.g., the receiving port 2004 and the sending port 2005. The processing circuitry 2030 may be configured to, or operable to, perform the method actions according to FIGS. 3-11 and 13 in a similar manner as that described in relation to FIG. 15a. The radio circuitry 2032 may be configured to set up and maintain at least a wireless connection with the network node 101. Circuitry may be understood herein as a hardware component.

The network node 101 may be operative to operate in the communications system 100. The network node 101 may comprise the processing circuitry 2030 and the memory 2003. The memory 2003 comprises instructions executable by the processing circuitry 2030. The network node 101 is operative to perform the actions described herein in relation to the network node 101, e.g., in FIGS. 3-11 and 13.

### Further Extensions and Variations

A telecommunication network may be connected via an intermediate network to a host computer.

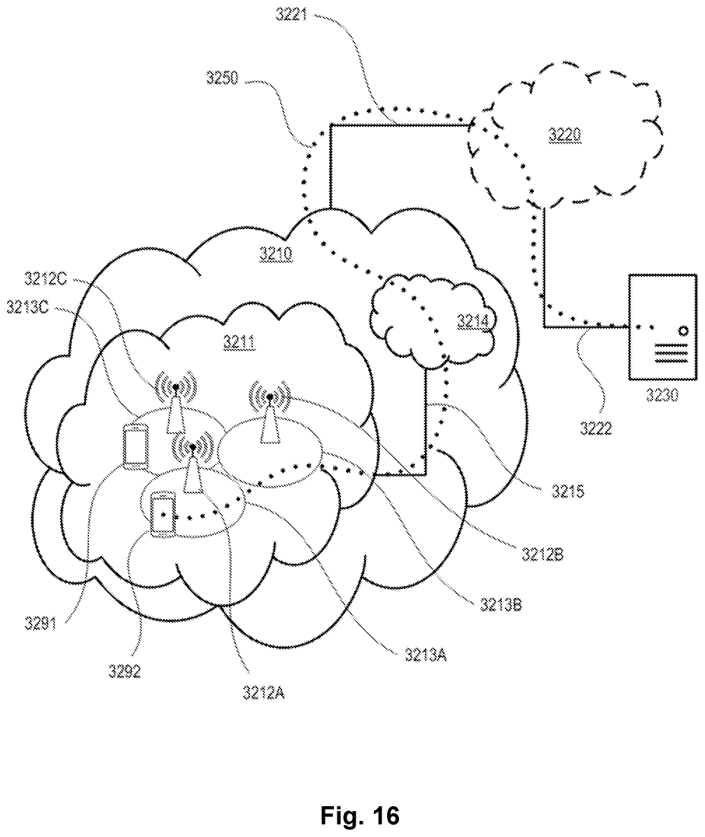

With reference to FIG. 16, a communication system comprises telecommunication network 3210 such as the communications system 100, for example, a 3GPP-type cellular network, which comprises access network 3211, such as a radio access network, and core network 3214. Access network 3211 comprises a plurality of network nodes 105. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 105 may be comprised in the communications system 100. In FIG. 16, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, it is equally applicable to a situation where a sole UE is in the coverage area or where a sole UE is connecting to the corresponding base station 3212. Any of the UEs 3291, 3292 may be considered examples of the UE 105.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 16 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

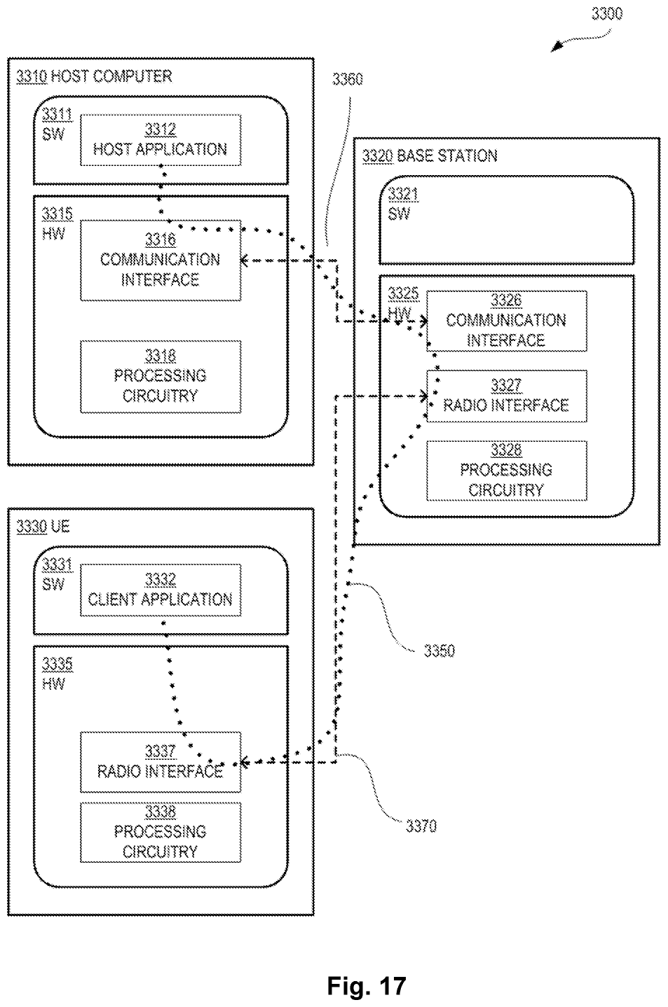

In relation to FIGS. 17-370 which are described next, it may be understood that the base station may be considered an example of the network node 101. FIG. 17 illustrates an example of host computer communicating via a network node 101 with a UE 105 over a partially wireless connection.

The UE 105 and the network node 101, e.g., a base station and host computer discussed in the preceding paragraphs will now be described with reference to FIG. 17. In communication system 3330, such as the communications system 100, host computer 3310 comprises hardware 3315 comprising communication interface 3316 configured to set up and maintain a wired or wireless connection with an interface of a different communication device of communication system 3300. Host computer 3310 comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 comprises software 3311, which is stored in or accessible by host computer 3310 and executable by processing circuitry 3318. Software 3311 comprises host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 comprises the network node 101 exemplified in FIG. 17 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 105, exemplified in FIG. 17 as a UE 3330 located in a coverage area served by base station 3320. Communication interface 3326 may be configured to facilitate connection 3360 to host computer 3310. Connection 3360 may be direct, or it may pass through a core network (not shown in FIG. 17) of the telecommunication system and/or through one or more intermediate networks outside the telecommunication system. Hardware 3325 of base station 3320 comprises processing circuitry 3328, which may comprise one or more programmable processors, application-specific integrated circuits, field programmable gate arrays or combinations of these (not shown) adapted to execute instructions. Base station 3320 has software 3321 stored internally or accessible via an external connection.

Communication system 3300 comprises UE 3330 already referred to. It's hardware 3335 may comprise radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 17 may be similar or identical to host computer 3230, one of base stations 3212a, 3212b, 3212c and one of UEs 3291, 3292 of FIG. 16, respectively. This is to say, the inner workings of these entities may be as shown in FIG. 17 and independently, the surrounding network topology may be that of FIG. 16.

In FIG. 17, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may take decisions by which it dynamically changes the routing, e.g. obased onload balancing consideration or reconfiguration of the network.

There may be a wireless connection 3370 between UE 3330 and base station 3320. The present disclosure improves the performance of OTT services provided to UE 3330 using OTT connection 3350, in which wireless connection 3370 forms the last segment. The present disclosure may improve the spectrum efficiency, and latency, and thereby provide benefits such as reduced user waiting time, better responsiveness, and extended battery lifetime.

A measurement procedure may be provided for the purpose of monitoring data rate, latency and other factors on which the present disclosure improves. There may be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may comprise message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310's measurements of throughput, propagation times, latency and the like. The measurements may be implemented in that software 3311 and 3331 causes messages to be transmitted, in particular empty or dummy messages, using OTT connection 3350 while it monitors propagation times, errors etc.

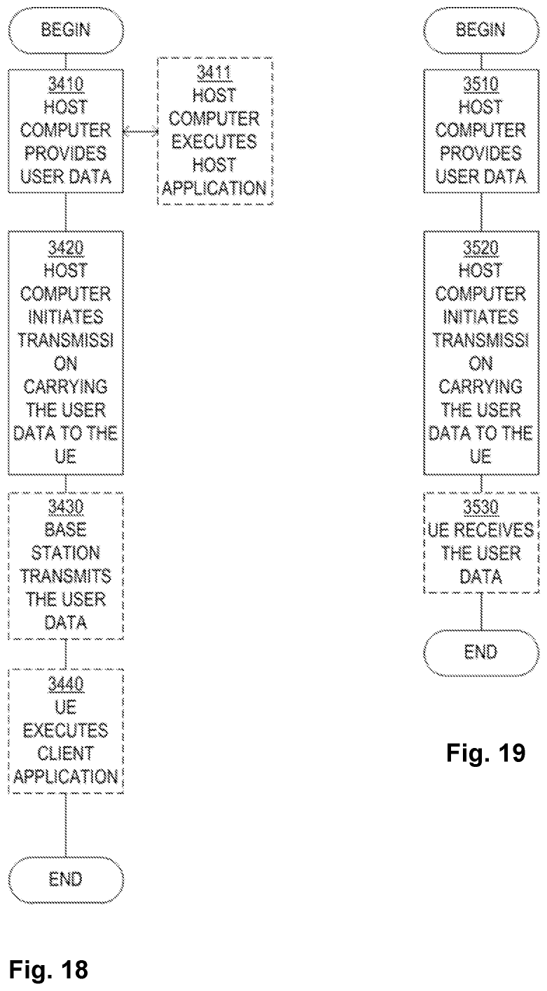

FIG. 18 illustrates an example of methods implemented in a communication system comprising a host computer, a base station and a UE 105. FIG. 18 is a flowchart illustrating a method implemented in a communication system. The communication system comprises a host computer, a base station and a UE 105 which may be those described with reference to FIG. 16 and FIG. 17. For simplicity of the present disclosure, only drawing references to FIG. 18 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits, to the UE 105, the user data which was carried in the transmission that the host computer initiated. In step 3440 (which may be optional), the UE executes a client application associated with the host application executed by the host computer.

FIG. 19 illustrates methods implemented in a communication system comprising a host computer, a base station and a UE 105. FIG. 19 is a flowchart illustrating a method implemented in a communication system. The communication system comprises a host computer, a base station and a UE 105 which may be those described with reference to FIG. 16 and FIG. 17. For simplicity of the present disclosure, only drawing references to FIG. 19 will be comprised in this section. In step 3510 of the method, the host computer provides user data. In an optional substep (not shown) the host computer provides the user data by executing a host application. In step 3520, the host computer initiates a transmission carrying the user data to the UE 105. The transmission may pass via the base station. In step 3530 (which may be optional), the UE 105 receives the user data carried in the transmission.

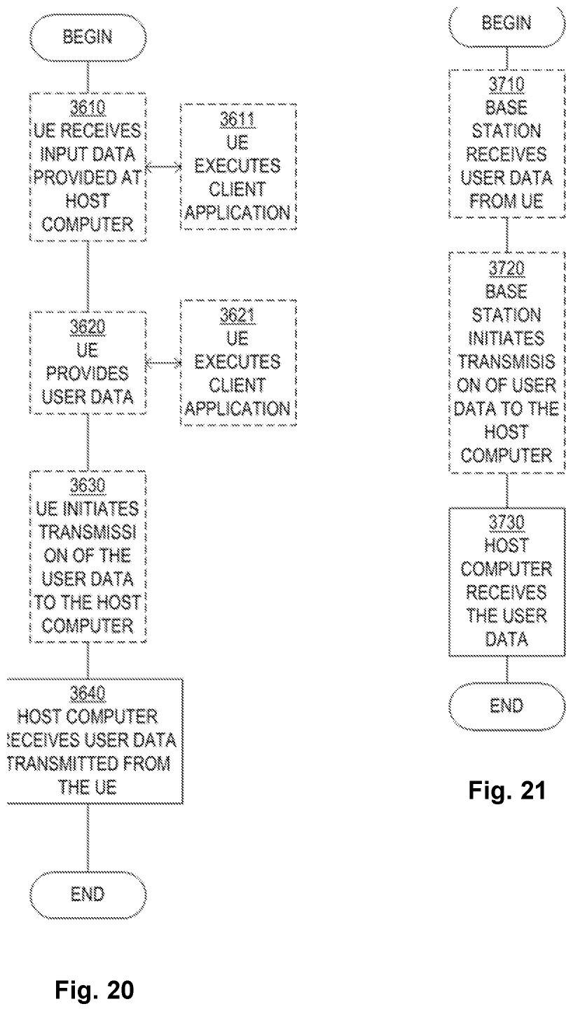

FIG. 20 illustrates methods implemented in a communication system comprising a host computer, a base station and a UE 105. FIG. 20 is a flowchart illustrating a method implemented in a communication system. The communication system comprises a host computer, a network node 101 and a UE 105 which may be those described with reference to FIG. 16 and FIG. 17. For simplicity of the present disclosure, only drawing references to FIG. 20 will be comprised in this section. In step 3610 (which may be optional), the UE 105 receives input data provided by the host computer. Additionally, or alternatively, in step 3620, the UE 105 provides user data. In substep 3621 (which may be optional) of step 3620, the UE 105 provides the user data by executing a client application. In substep 3611 (which may be optional) of step 3610, the UE 105 executes a client application which provides the user data in reaction to the received input data provided by the host computer. In providing the user data, the executed client application may consider user input received from the user. Regardless of the specific way the user data was provided, the UE 105 initiates, in substep 3630 (which may be optional), transmission of the user data to the host computer. In step 3640 of the method, the host computer receives the user data transmitted from the UE 105.

FIG. 21 illustrates methods implemented in a communication system comprising a host computer, a base station and a UE 105. FIG. 21 is a flowchart illustrating a method implemented in a communication system. The communication system comprises a host computer, a base station and a UE 105 which may be those described with reference to FIG. 16 and FIG. 17. For simplicity of the present disclosure, only drawing references to FIG. 21 will be comprised in this section. In step 3710 (which may be optional), the base station receives user data from the UE 105. In step 3720 (which may be optional), the base station initiates transmission of the received user data to the host computer. In step 3730 (which may be optional), the host computer receives the user data carried in the transmission initiated by the base station.

The present disclosure may be summarized as follows:

A base station is configured to communicate with a UE 105. The base station comprises a radio interface and processing circuitry configured to perform one or more of the actions described herein as performed by the network node 101.

A communication system 100 comprises a host computer, and the communication system 100 comprises:
processing circuitry configured to provide user data; and
a communication interface configured to forward the user data to a cellular network for transmission to a UE 105,
wherein the cellular network comprises a network node 101 having a radio interface and processing circuitry, the base station's processing circuitry configured to perform one or more of the actions described herein as performed by the network node 101.

The communication system 100 may comprise the network node 101.

The communication system 100 may comprise the UE 105. The UE 105 is configured to communicate with the network node 101.

The communication system 101, wherein:
the processing circuitry of the host computer is configured to execute a host application, thereby providing the user data; and
the UE 105 comprises processing circuitry configured to execute a client application associated with the host application.

A method implemented in a network node 101. The method comprises one or more of the actions described herein as performed by the network node 101.

A method implemented in a communication system 100 comprising a host computer, a base station and a UE 105, the method comprising:
at the host computer, providing user data; and
at the host computer, initiating a transmission carrying the user data to the UE 105 via a cellular network comprising the network node 101, wherein the network node 101 performs one or more of the actions described herein as performed by the network node 101.

The method may comprise:
at the network node 101, transmitting the user data.

The user data may be provided at the host computer by executing a host application, and the method may comprise:
at the UE 105, executing a client application associated with the host application.

A UE 105 configured to communicate with a network node 101. The UE 105 comprises a radio interface and processing circuitry configured to perform one or more of the actions described herein as performed by the UE 105.

A communication system 100 comprises a host computer. The communication system 100 comprises:
processing circuitry configured to provide user data; and
a communication interface configured to forward user data to a cellular network for transmission to a UE 105,
wherein the UE 105 comprises a radio interface and processing circuitry, the UE's processing circuitry configured to perform one or more of the actions described herein as performed by the UE 105.

The communication system 100 may comprise the UE 105.

The communication system 100, wherein the cellular network comprises a network node 101 configured to communicate with the UE 105.

The communication system 100, wherein:
the processing circuitry of the host computer is configured to execute a host application, thereby providing the user data; and
the UE's processing circuitry is configured to execute a client application associated with the host application.

A method implemented in a UE 105, comprising one or more of the actions described herein as performed by the UE 105.

A method implemented in a communication system 100 comprising a host computer, a network node 101 and a UE 105, the method comprising:
at the host computer, providing user data; and
at the host computer, initiating a transmission carrying the user data to the UE 105 via a cellular network comprising the base station, wherein the UE 105 performs one or more of the actions described herein as performed by the UE 105.

The method may comprise:
at the UE 105, receiving the user data from the network node 101.

A UE 105 configured to communicate with a network node 101, the UE 105 comprising a radio interface and processing circuitry configured to perform one or more of the actions described herein as performed by the UE 105.

A communication system 100 comprising a host computer comprising:
a communication interface configured to receive user data originating from a transmission from a UE 105 to a network node 101,
wherein the UE 105 comprises a radio interface and processing circuitry, the UE's processing circuitry configured to: perform one or more of the actions described herein as performed by the UE 105.

The communication system 100 may comprise the UE 105.

The communication system 100 may comprise the network node 101, wherein the network node 101 comprises a radio interface configured to communicate with the UE 105 and a communication interface configured to forward to the host computer the user data carried by a transmission from the UE 105 to the base station.

The communication system 100, wherein:
the processing circuitry of the host computer is configured to execute a host application; and
the UE's processing circuitry is configured to execute a client application associated with the host application, thereby providing the user data.

The communication system 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 105, comprising one or more of the actions described herein as performed by the UE 105.

The method may comprise:
providing user data; and
forwarding the user data to a host computer via the transmission to the network node 101.

A method implemented in a communication system 100 comprising a host computer, a network node 101 and a UE 105, the method comprising:
at the host computer, receiving user data transmitted to the network node 101 from the UE 105, wherein the UE 105 performs one or more of the actions described herein as performed by the UE 105.

The method may comprise:
at the UE 105, providing the user data to the network node 101.

The method may comprise:
at the UE 105, executing a client application, thereby providing the user data to be transmitted; and
at the host computer, executing a host application associated with the client application.

The method may comprise:
at the UE 105, executing a client application; and
at the UE 105, receiving input data to the client application, the input data being provided at the host computer by executing a host application associated with the client application,
wherein the user data to be transmitted is provided by the client application in response to the input data.

A network node 101 configured to communicate with a UE 105, the network node 101 comprising a radio interface and processing circuitry configured to perform one or more of the actions described herein as performed by the network node 101.

A communication system 100 comprising a host computer comprising a communication interface configured to receive user data originating from a transmission from a UE 105 to a base station, wherein the network node 101 comprises a radio interface and processing circuitry, the base station's processing circuitry configured to perform one or more of the actions described herein as performed by the network node 101.

The communication system 100 may comprise the network node 101.

The communication system 100 may comprise the UE 105, wherein the UE 105 is configured to communicate with the network node 101.

The communication system 100 wherein:
the processing circuitry of the host computer is configured to execute a host application;
the UE 105 is configured to execute a client application associated with the host application, thereby providing the user data to be received by the host computer.

A method implemented in a network node 101, comprising one or more of the actions described herein as performed by any of the network node 101.

A method implemented in a communication system comprising a host computer, a network node 101 and a UE 105, the method comprising:
at the host computer, receiving, from the network node 101, user data originating from a transmission which the base station has received from the UE 105, wherein the UE 105 performs one or more of the actions described herein as performed by the UE 105.

The method may comprise:
at the network node 101, receiving the user data from the UE 105.

The method may comprise:
at the network node 101, initiating a transmission of the received user data to the host computer.

Summarized, the present disclosure relates to a re-configuring a of a MPM at the UE 105, possibly based on reports the UE 105 transmits to the network node 101 with information related to the MPM, such as the error and/or accuracy of the MPM outputs. The outputs of the MPM may comprise predicted mobility related information e.g. predicted RSRP, predicted next cell the UE 105 is moving to, etc. Hence, the UE 105 may be either initially configured with at least one MPM, e.g. during connection setup/establishment, and/or has an MPM as a software function, e.g. if that is implemented at the UE 105. that is re-configured/updated. Examples of parameters of the MPM that may be re-configured are provided above, such modifying/adding/releasing the weights of an MPM based on neural network, how far in the future predictions should be performed, e.g. at to, predictions at t0+T wherein T is the configurable/re-configurable value.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should be noted that the words “a” or “an” preceding an element do not exclude the presence of a plurality of such elements.

The term “configured to” used herein may be referred to as “arranged to”, “adapted to”, “capable of” or “operative to”.

The steps of the methods may be performed in another order than the order in which they appear herein.

1-28. (canceled)

29. A method performed by a User Equipment (UE) for handling Mobility Prediction Model (MPM) re-configuration in a communications system, wherein the UE is configured with a first MPM, the method comprising:
performing mobility predictions using the first MPM;
providing a report from the mobility predictions to a network node;
obtaining MPM re-configuration information from the network node; and
performing MPM re-configuration according to the obtained MPM-re-configuration information.

30. The method according to claim 29, wherein the report from the mobility predictions comprises one or both of:
a measurement report comprising a result of the performed mobility predictions; or
information related to the first MPM used in the mobility predictions.

31. The method according to claim 30, wherein the information related to the first MPM comprises any one or more of:
MPM error information associated with the use of the first MPM in the mobility predictions;
MPM accuracy information associated with the use of the first MPM in the mobility predictions; or
MPM performance information associated with the use of the first MPM in the mobility predictions.

32. The method according to claim 30, further comprising determining the information related to the first MPM.

33. The method according to claim 29, wherein performing the MPM re-configuration comprises any one or more of:
updating the first MPM;
modifying the first MPM;
replacing the first MPM with a second MPM;
switching from the first MPM to a second MPM, with which the UE is already configured; or
deactivating mobility predictions.

34. The method according to claim 29, wherein the MPM re-configuration information comprises any one or more of:
an updated MPM;
a modified MPM;
a second MPM;
information indicating a switch from the first MPM to a second MPM, with which the UE is already configured; or
information indicating deactivation of the mobility predictions.

35. The method according to claim 29, further comprising, based on at least a part of the information related to the first MPM, determining an action to be performed by the UE.

36. The method according to claim 35, wherein the action to be performed is any one or more of:
continue to perform mobility predictions using the first MPM;
stop performing predictions using the first MPM;
provide MPM error information to the network node;
deactivate the first MPM;
switch to use a second MPM instead of the first MPM;
re-train the first MPM;
release the first MPM; or
stop providing information related to the first MPM to the network node.

37. The method according to claim 29, wherein the UE is configured with multiple MPMs, and wherein the method comprises obtaining, from the network node, information indicating which one of the multiple MPMs to be used.

38. The method according to claim 29, wherein the re-configuration is performed during a mobility procedure.

39. The method according to claim 29, wherein the UE is in RRC_CONNECTED mode.

40. A method performed by a network node for handling Mobility Prediction Model (MPM) re-configuration in a communications system, the method comprising:
obtaining a report from the mobility predictions from a User Equipment (UE);
determining that MPM re-configuration should be performed; and
providing MPM re-configuration information to the UE.

41. The method according to claim 40, wherein the MPM re-configuration is determined based on the obtained report or any one of triggering, preparation, or execution of a mobility procedure.

42. The method according to claim 40, wherein the report from the mobility predictions comprises a least one of: a measurement report comprising a result of the performed mobility predictions; or information related to a first MPM used in the mobility predictions.

43. The method according to claim 42, wherein the information related to the first MPM comprises any one or more of:
MPM error information associated with the use of the first MPM in the mobility predictions;
MPM accuracy information associated with the use of the first MPM in the mobility predictions; or
MPM performance information associated with the use of the first MPM in the mobility predictions.

44. The method according to claim 42, further comprising determining information related to the first MPM.

45. The method according to claim 40, wherein the MPM re-configuration comprises
any one or more of:
updating a first MPM;
modifying the first MPM;
replacing the first MPM with a second MPM;
switching from the first MPM to a second MPM with which the UE is already configured; or
deactivating the mobility predictions.

46. The method according to claim 40, wherein the MPM re-configuration information comprises any one or more of:
an updated MPM;
a modified MPM;
a second MPM;
information indicating a switch from the first MPM to a second MPM with which the UE is already configured; or
information indicating deactivation of the mobility predictions.

47. A User Equipment (UE) for handling Mobility Prediction Model (MPM) re-configuration in a communications system, wherein the UE is configured with a first MPM and the UE comprises:
a communications interface configured for communicating with network nodes of the communications system; and
processing circuitry configured to:
perform mobility predictions using the first MPM;
provide, via the communications interface, a report from the mobility predictions to a network node of the communications system;
obtain, via the communications interface, MPM re-configuration information from the network node; and
perform MPM re-configuration according to the obtained MPM-re-configuration information.

48. A network node for handling Mobility Prediction Model (MPM) re-configuration in a communications system, the network node comprising:
a communications interface; and
processing circuitry configured to:
obtain, via the communications interface, a report from the mobility predictions from a User Equipment (UE);
determine that MPM re-configuration should be performed; and
provide, via the communications interface, MPM re-configuration information to the UE.
